(19) United States
(12) Patent Application Publication
(10) Pub. No.: US 2026/0318519 A1
(43) Pub. Date: Oct. 15, 2026

(54) Wirelessly-Controllable Lighting Device

(71) Applicant: Lutron Technology Company LLC, Coopersburg, PA (US)

(72) Inventors: Aaron J. Wilz, Emmaus, PA (US); Scott Larson, Attleboro, MA (US); Kaiming Li, Allentown, PA (US); Benjamin T. Voth, Quakertown, PA (US)

(73) Assignee: Lutron Technology Company LLC, Coopersburg, PA (US)

(21) Appl. No.: 19/565,705

(22) Filed: Mar. 13, 2026

Related U.S. Application Data
(60) Provisional application No. 63/771,280, filed on Mar. 13, 2025.

(51) Int. Cl. F21V 23/00; F21S 8/02; F21V 7/04; F21V 7/24; F21V 19/00; F21V 29/70; F21Y 105/18; F21Y 115/10

(52) U.S. Cl. CPC F21V 23/005; F21S 8/026; F21V 7/041; F21V 7/24; F21V 19/004; F21V 29/70; F21Y 2105/18; F21Y 2115/10

(57) ABSTRACT

A lighting device that may be mounted in an opening in a building structure may be configured to transmit and receive wireless signals, such as radio-frequency (RF) signals. The lighting device may comprise at least one emitter, a heat sink, a reflector, a printed circuit board assembly, and an antenna for transmitting and receiving the wireless signals. The printed circuit board may comprise an extension extending through an opening in a rear wall of the heat sink and into a recess defined by the heat sink. The antenna may comprise a base that mechanically connects the antenna to the extension of the printed circuit board, and an arm that extends from the base and towards an aperture of a trim portion of the lighting device. The antenna may curve around the reflector between the reflector and the heat sink.

### CROSS-REFERENCE TO RELATED APPLICATIONS

This application claims benefit of Provisional U.S. Patent Application No. 63/771,280, filed Mar. 13, 2025, the entire disclosure of which is hereby incorporated by reference.

### BACKGROUND

Lamps and displays using efficient light sources, such as light-emitting diode (LED) light sources, for illumination are becoming increasingly popular in many different markets. LED light sources provide a number of advantages over traditional light sources, such as incandescent and fluorescent lamps. For example, LED light sources may have a lower power consumption and a longer lifetime than traditional light sources. When used for general illumination, LED light sources provide the opportunity to adjust the color (e.g., from white, to blue, to green, etc.) or the color temperature (e.g., from warm white to cool white) of the light emitted from the LED light sources to produce different lighting effects.

### SUMMARY

As described herein, a lighting device configured to be mounted in an opening in a building structure may be configured to transmit and receive wireless signals, such as radio-frequency (RF) signals. The lighting device may comprise an emitter printed circuit board assembly, a trim portion, a heat sink, a reflector, a control printed circuit board assembly, and an antenna for transmitting and receiving the wireless signals. The emitter printed circuit board assembly may comprise a plurality of emitters mounted to an emitter printed circuit board. The trim portion may define an aperture through which the emitters of the emitter printed circuit board may be configured to emit light. The heat sink may comprise a body that includes a rear wall and at least one side wall extending from the rear wall. The rear wall and the at least one side wall of the heat sink may define a recess in which the emitter printed circuit board assembly is received. The reflector may comprise a body having a first opening at a first end and a second opening at a second end. The body of the reflector may extend into the recess of the heat sink such that the emitters of the emitter printed circuit board assembly are configured to emit light through the first opening of the reflector. The reflector may be configured to reflect the light emitted by the emitters through the second opening of the reflector. The control printed circuit board assembly may comprise a control printed circuit board having mounted thereto one or more drive circuits for controlling the emitters of the emitter printed circuit board assembly and one or more wireless communication circuits configured to communicate the RF signals. The control printed circuit board may comprise an extension extending through an opening in the rear wall of the heat sink and into the recess defined by the heat sink. The antenna may be electrically coupled to the one or more wireless communication circuits mounted to the control printed circuit board. The antenna may comprise a base and an arm extending from the base. The base may mechanically connect the antenna to the extension of the control printed circuit board. The arm of the antenna may extend from a first end at the base, towards the reflector and the aperture of the trim portion, and to a second end distal the first end. In some examples, the second end of the antenna may be proximate to the reflector.

In some examples, a lighting device configured to be mounted in an opening in a building structure may comprise at least one emitter configured to emit light, a heat sink, a reflector, an enclosure, a printed circuit board, and an antenna for transmitting and receiving the wireless signals, such as RF signals. The heat sink may comprise a heat sink body that includes a rear wall and at least one side wall extending from the rear wall, such that the rear wall and the at least one side wall of the heat sink define a recess. The at least one emitter may be received in the recess of the heat sink and may be thermally coupled to the heat sink. The reflector comprising a reflector body having a first opening at a first reflector end and a second opening at a second reflector end.

The reflector body may extend into the recess of the heat sink, such that the at least one emitter is configured to emit light through the first opening of the reflector, and the reflector reflects the light emitted by the at least one emitter through the second opening of the reflector. The printed circuit board may have mounted thereto one or more drive circuits configured to control the at least one emitter and one or more wireless communication circuits configured to communicate radio-frequency (RF) signals. The printed circuit board may comprise an extension extending through an opening in the rear wall of the heat sink and into the recess defined by the heat sink. The antenna may be electrically coupled to the one or more wireless communication circuits mounted to the printed circuit board. The antenna may comprise a base that mechanically connects the antenna to the extension of the printed circuit board. The antenna may further comprise an arm that may extend from a first antenna end connected to the base, towards the second reflector end of the reflector, and to a second antenna end that is distal the first antenna end and proximate the second reflector end of the reflector.

Further, a lighting device configured to be mounted in an opening in a building structure may comprise at least one emitter configured to emit light, a heat sink, a reflector, an enclosure, a printed circuit board, an enclosure, and an antenna for transmitting and receiving the wireless signals, such as RF signals. The heat sink may comprise a heat sink body that includes a rear wall and at least one side wall extending from the rear wall, such that the rear wall and the at least one side wall of the heat sink may define a recess. The at least one emitter may be received in the recess of the heat sink and may be thermally coupled to the heat sink. The reflector may comprise a reflector body having a first opening at a first reflector end and a second opening at a second reflector end. The reflector body may extend into the recess of the heat sink, such that the at least one emitter is configured to emit light through the first opening of the reflector, and the reflector reflects the light emitted by the at least one emitter through the second opening of the reflector. The enclosure may be attached to the heat sink and may define a cavity in which the printed circuit board is received. The enclosure may comprise support structures on opposing sides of the cavity for supporting the printed circuit board. The printed circuit board may have mounted thereto one or more drive circuits configured to control the at least one emitter and one or more wireless communication circuits configured to communicate radio-frequency (RF) signals. The printed circuit board may comprise attachment tabs on opposing edges of the printed circuit board. The printed circuit board may be received within the cavity of the enclosure and the attachment tabs may engage with the support structures of the enclosure, such that the printed circuit board may be oriented perpendicular to the rear wall of the heat sink and an extension of the printed circuit board may extend through an opening in the rear wall of the heat sink and into the recess defined by the heat sink. The antenna may be electrically coupled to the one or more wireless communication circuits mounted to the printed circuit board. The antenna may comprise a base that mechanically connects the antenna to the extension of the printed circuit board, and arm that extends from the base.

### BRIEF DESCRIPTION OF THE DRAWINGS

FIG. 1 is a bottom perspective view of an example of a lighting device.

FIG. 2 is an exploded view of the lighting device of FIG. 1.

FIG. 3 is a side view of the lighting device of FIG. 1 with a trim portion, a reflector, and a heat sink removed.

FIG. 4 is a bottom perspective view of the lighting device of FIG. 1 with the trim portion and the reflector removed.

FIG. 5 is a bottom view of the lighting device of FIG. 1 with the trim portion and the reflector removed.

FIG. 6 is a side cross-section view of the lighting device of FIG. 1 with the trim portion and the reflector removed (e.g., taken through the line shown in FIG. 3).

FIG. 7 is an enlarged perspective view of an enclosure (e.g., a rear enclosure) and a control printed circuit board assembly of the lighting device of FIG. 1.

FIG. 8 is a bottom perspective view of an example of a lighting device.

FIG. 9 is an exploded view of the lighting device of FIG. 8.

FIG. 10 is a side view of the lighting device of FIG. 8 with a trim portion, a reflector, and a heat sink removed.

FIG. 11 is a bottom perspective view of the lighting device of FIG. 8 with the trim portion and the reflector removed.

FIG. 12 is a bottom view of the lighting device of FIG. 8 with the trim portion and the reflector removed.

FIG. 13 is a side cross-section view of the lighting device of FIG. 8 with the trim portion and the reflector removed (e.g., taken through the line shown in FIG. 10).

FIG. 14 is another side cross-section view of the lighting device of FIG. 8 with the trim portion and the reflector removed (e.g., taken through the line shown in FIG. 13).

FIG. 15 is a perspective view of the lighting device of FIG. 8 with the trim portion, the reflector, and the heat sink removed.

FIG. 16 is an enlarged perspective view of an enclosure (e.g., a rear enclosure) and a control printed circuit board assembly of the lighting device of FIG. 8.

FIG. 17 is a block diagram of an example of a lighting device, such as the lighting device shown in FIG. 1 and/or the lighting device shown in FIG. 8.

### DETAILED DESCRIPTION

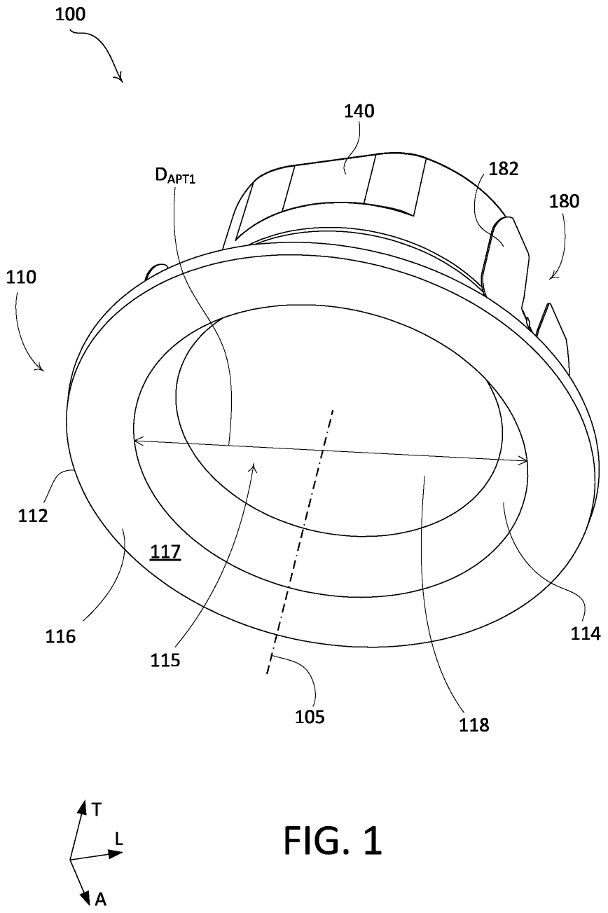

FIGS. 1-6 depict an example illumination device, such as a lighting device 100 (e.g., a controllable lighting device). The lighting device 100 may be configured to be installed within a building structure (e.g., such as a ceiling, ceiling tile, etc.), for example, as part of a retrofit installation. For example, the lighting device 100 may be configured to be installed in a circular (e.g., cylindrically-shaped) downlight housing that may be presently installed in the building structure. The building structure (e.g., the ceiling) in which the downlight housing may be installed may be located in a plane that extends in a longitudinal direction L and a lateral direction A. The lighting device 100 may be configured to be electrically coupled to a power source, such as an alternating-current (AC) power source and/or a direct-current (DC) power source.

FIG. 1 is a bottom perspective view of the lighting device 100. The lighting device 100 may comprise a trim portion 110 that includes a trim ring 112 having a sleeve 114, a bezel 116 (e.g., a flange), and a bottom surface 117 (e.g., a bottom surface of the bezel 116). The trim portion 110 (e.g., the trim ring 112) may comprise (e.g., define) an aperture 115 through which the lighting device 100 may be configured to emit light (e.g., as will be described in greater detail below). For example, the aperture 115 may have a circular shape (e.g., may be a circle). The aperture 115 may be located in a plane that extends in the longitudinal direction L and the lateral direction A at the bottom surface 117 of the trim ring 112. For example, the aperture 115 may be characterized by a diameter D_{APT1} (e.g., approximately 4-6 inches).

The trim portion 110 may further comprise a diffuser 118 (e.g., a lens). The diffuser 118 may be transparent or translucent, and may be made of any suitable material, for example plastic or glass. The diffuser 118 may cover the aperture 115 of the trim portion 110, such that the light emitted by the lighting device 100 may be transmitted through the diffuser 118. For example, the diffuser 118 may diffuse (e.g., scatter) the light transmitted through the aperture 115.

The diffuser 118 may be located in a plane that extends in the longitudinal direction L and the lateral direction A. The lighting device 100 may define an axis 105 (e.g., a central axis) that extends through a center of the trim portion 110 (e.g., the trim ring 112 and/or the aperture 115) in a transverse direction T.

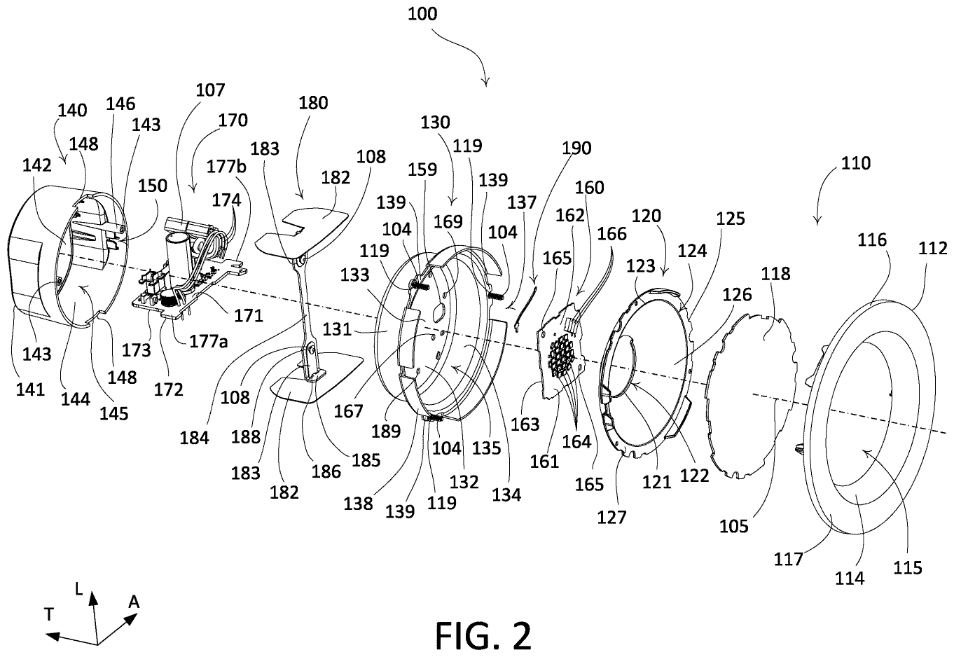

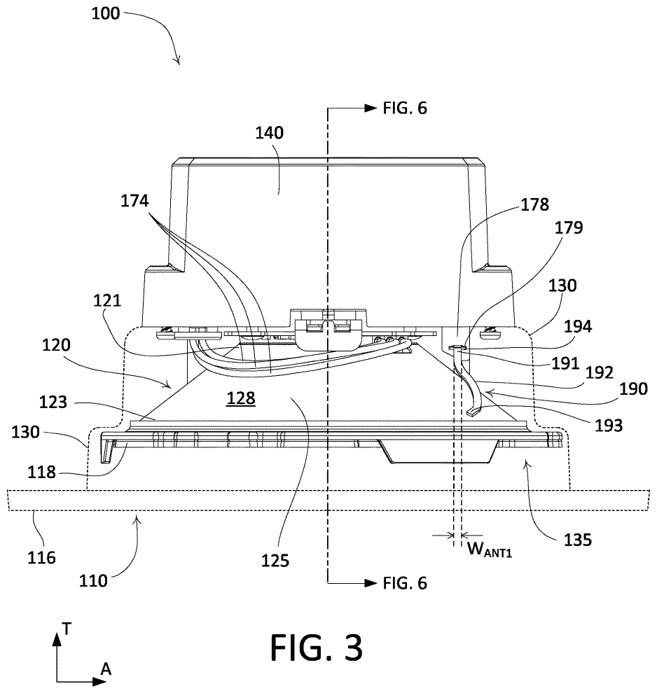

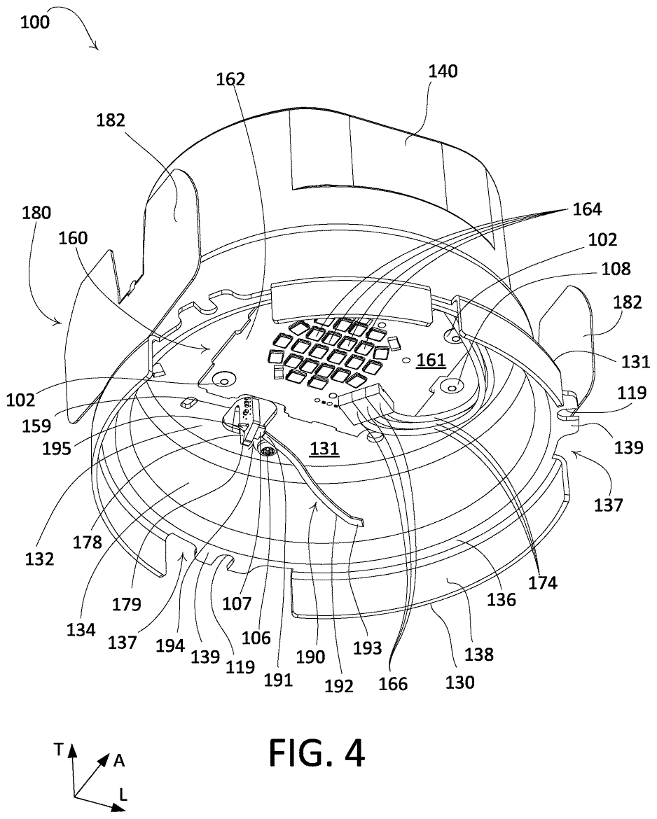

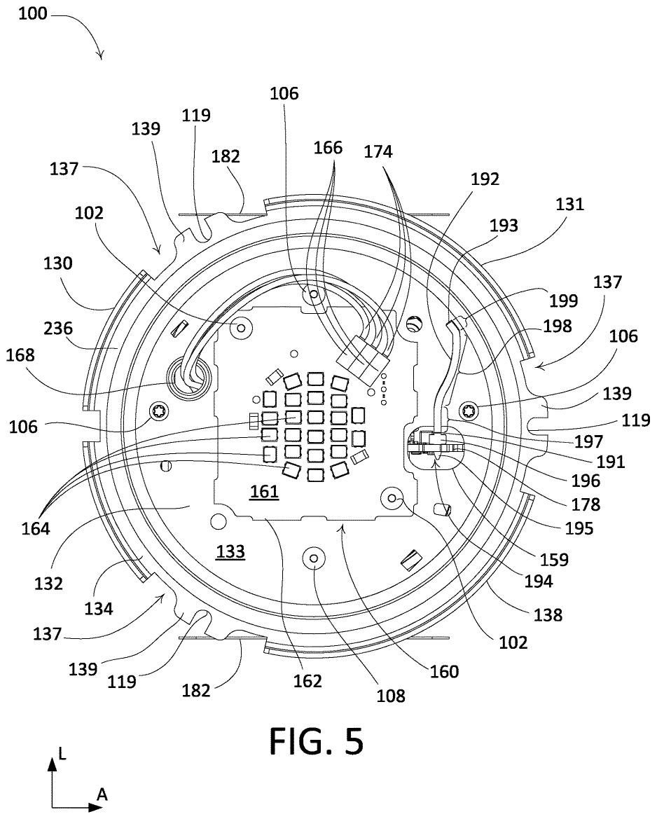

FIG. 2 is an exploded view of the lighting device 100. The lighting device 100 may further comprise a reflector 120, a heat sink 130, an enclosure 140 (e.g., a rear enclosure), an emitter printed circuit board (PCB) assembly 160 (e.g., a first PCB assembly), a control printed circuit board (PCB) assembly 170 (e.g., a second PCB assembly), and a mounting bracket 180. FIG. 3 is a side view of the lighting device 100 with the trim portion 110, the reflector 120, and the heat sink 130 removed. The location of the trim portion 110 (e.g., the bezel 116 of the trim ring 112) and the heat sink 130 are shown by dashed lines in FIG. 3. FIG. 4 is a bottom perspective view and FIG. 5 is a bottom view of the lighting device 100 with the trim portion 110 and the reflector 120 removed.

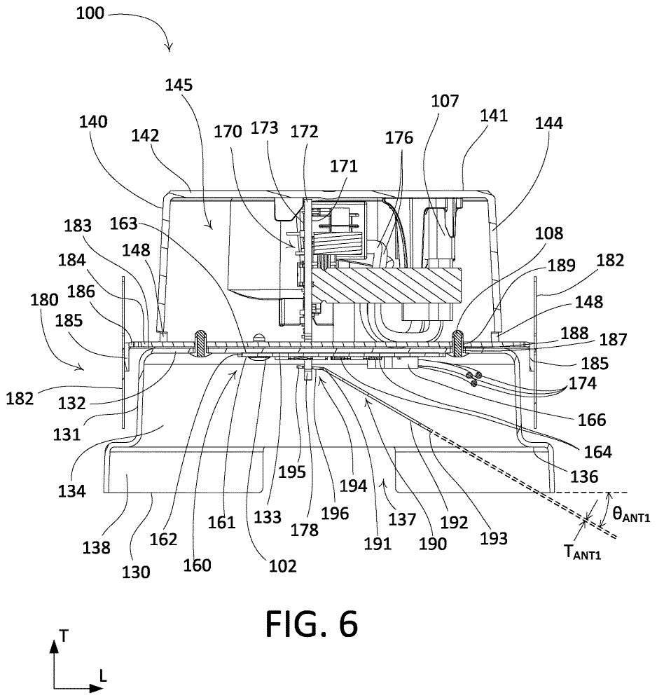

FIG. 6 is a side cross-section view of the lighting device 100 with the trim portion 110 and the reflector 120 removed taken through the line shown in FIG. 3.

The emitter PCB assembly 160 may comprise an emitter printed circuit board (PCB) 162 (e.g., a first PCB). The emitter PCB 162 may have a first side 161 (e.g., a front side) and a second side 163 (e.g., a rear side) that is opposed to the first side 161. The emitter PCB assembly 160 may comprise a plurality of emitters 164 (e.g., emission light-emitting diodes) mounted to the emitter PCB 162 (e.g., to the first side 161 of the emitter PCB 162). For example, the emitter PCB assembly 160 may comprise 24 emitters 164 (e.g., as shown in FIGS. 2, 4 and 5). In some examples, the emitter PCB assembly 160 may include more or less emitters 164 than shown in FIGS. 2, 4 and 5. The emitter PCB assembly 160 may include multiple “chains” of the emitters 164 (e.g., series-coupled emitters). The emitters 164 of each chain may be coupled in series and may conduct the same drive current. Each chain may include emitters 164 that produce illumination at the same peak emission wavelength (e.g., emit light of the same color) and/or the same color temperature. The emitters 164 of different chains may emit light of different colors and/or color temperatures. For example, the emitter PCB assembly 160 may comprise two chains each of emitters 164 (e.g., 12 emitters) that are configured to emit light at respective different color temperatures (e.g., a warm-white color temperature and a cool-white color temperature). The individual emitters 164 in each chain may be scattered about the emitter PCB 162 to improve color mixing within the emitter PCB assembly 160. Other variations of numbers of the emitters 164 in each chain, the colors and/or color temperatures of the emitters 164, the numbers of the colors and/or color temperatures of the emitters 164, the number of chains of the emitters 164, the number of chains that emit light of a same color, etc., may be used. Other variations are possible.

The heat sink 130 may comprise a body 131 having a rear wall 132 (e.g., a plate portion) and a side wall 134. The rear wall 132 of the body 131 may be oriented parallel to the diffuser 118 of the trim portion 110 (e.g., in a plane extending in the longitudinal direction L and the lateral direction A). The side wall 134 of the body 131 may extend approximately perpendicular from the rear wall 132 (e.g., in the transverse direction T). The heat sink 130 (e.g., the rear wall 132 and the side wall 134) may comprise (e.g., define) a recess 135 (e.g., a cavity) in which the emitter PCB assembly 160 may be received. For example, the body 131 (e.g., the side wall 134) may be cylindrical in shape. In some examples, the body 131 may be rectangular in shape (e.g., the body 131 may comprise four side walls connected to the rear wall 132 to form the recess 135). The emitter PCB 162 of the emitter PCB assembly 160 (e.g., the second side 163) may be mounted to a mounting surface 133 on the rear wall 132 of the heat sink 130. The emitters 164 of the emitter PCB assembly 160 may be thermally coupled to the heat sink 130 via the emitter PCB 162. The heat sink 130 (e.g., the body 131) may dissipate heat generated by the emitters 164 of the emitter PCB assembly 160. For example, the heat sink 130 (e.g., the body 131) may be made from a thermally-conductive material, such as metal (e.g., aluminum). A thermally-conductive substance may be disposed between the emitter PCB 162 and the heat sink 130. The emitter PCB assembly 160 may be attached to the heat sink 130 (e.g., the rear wall 132) via fasteners 102 (e.g., screws) received through openings 165 in the emitter PCB 162 and openings 167 in the heat sink 130 (e.g., in the rear wall 132).

The body 131 of the heat sink 130 may comprise a ledge portion 136 extending from the extending from the side wall 134 (e.g., in a plane extending in the longitudinal direction L and the lateral direction A) and a rim portion 138 extending from the ledge portion 136 (e.g., perpendicular to the ledge portion 136). For example, an opening formed by the rim portion 138 may be characterized by a larger diameter than a diameter of the opening formed by the side wall 134. The rim portion 138 may comprise gaps 137 spaced around a perimeter (e.g., a circumference) of the side wall 134 (e.g., and around a perimeter of the rim portion 138). The body 131 of the heat sink 130 may further comprise tabs 139 extending radially from the side wall 134 and positioned in the gaps 137 of the rim portion 138 (e.g., in a plane extending in the longitudinal direction L and the lateral direction A). For example, three of the gaps 137 may have the tabs 139 positioned within them (e.g., as shown in FIGS. 2, 4, and 5) although fewer or additional of the gaps 137 having the tabs 139 may be used. The trim portion 110 (e.g., the trim ring 112) may couple (e.g., mount) to the heat sink 130, for example, with the sleeve 114 of the trim ring 112 received in the recess 135 of the heat sink 130. For example, the heat sink 130 may be attached to the trim portion 110 (e.g., the trim ring 112) via respective fasteners 104 (e.g., three fasteners) received through respective slots 119 in the tabs 139 of the body 131 of the heat sink 130 (e.g., as shown in FIG. 2) and respective openings (not shown) in the trim ring 112. The trim ring 112 may include respect extensions (e.g., three extensions) that include the respective openings where the extensions fit or mate within each of the gaps 137 thereby aligning the slots 119 in the tabs 139 of the body 131 with the openings (not shown) in the trim ring 112.

The reflector 120 may comprise a body 125 (e.g., a conically-shaped body) having a first opening 122 at a first end 121 (e.g., a first reflector end) of the reflector 120 and a second opening 124 at a second end 123 (e.g., a second reflector end) of the reflector 120 (e.g., as shown in FIG. 2). The body 125 of the reflector 120 may include an inner surface 126 and an outer surface 128. The body 125 of the reflector 120 may further comprise a flange 127 surrounding the second opening 124 at the second end 123. The reflector 120 may be centered about the axis 105 of the lighting device 100 (e.g., the axis 105 may extend through the center of the first opening 122 and/or the second opening 124 of the reflector 120). The trim ring 112 of the trim portion 110 may attach to the heat sink 130 with the diffuser 118 and the reflector 120 (e.g., the flange 127 of the body 125 of the reflector 120) captured between the heat sink 130 (e.g., the side wall 134) and the trim ring 112 (e.g., the sleeve 114). The flange 127 (e.g., a top side of the flange 127) of the reflector 120 may rest on the ledge portion 136 of the heat sink 130. The lens 118 may be captured between the flange 127 (e.g., a bottom side opposite the top side of the flange 127) of the reflector 120 and the extensions of the trim ring 112. When the trim ring 112 is attached to the heat sink 130, the body 125 of the reflector 120 may extend into the recess 135 of the heat sink 130 (e.g., as shown in FIG. 3). The reflector 120 may be made from, for example, a non-conductive material (e.g., such as plastic). For example, the inner surface 126 of the reflector 120 may be a reflective surface (e.g., a white surface or a mirrored surface). When the reflector 120 is captured between the trim ring 112 and the heat sink 130, the first opening 122 of the reflector 120 may be centered over the emitters 164 on the emitter PCB 162, such that the emitters 164 may emit light through the first opening 122 of the reflector 120. The reflector 120 (e.g. the inner surface 126) may reflect light emitted by the emitters 164 through the second opening 124 of the reflector 120, the diffuser 118, and the aperture 115 of the trim portion 110.

The control PCB assembly 170 may comprise a control printed circuit board (PCB) 172 (e.g., a second PCB). The control PCB 172 may have a first side 171 and a second side 173 opposing the first side 171. The control PCB 172 may have mounted thereto electrical circuitry including one or more drive circuits for controlling the amount of power delivered to the emitters 164 of the emitter PCB assembly 160, one or more control circuits for controlling the drive circuits, and one or more wireless communication circuits for communicating wireless signals (e.g., radio-frequency (RF) signals) with external devices. For example, the wireless communication circuit of the control PCB assembly 170 may be configured to communicate the wireless signals at a communication frequency f_{COMM} (e.g., approximately 2.4 GHz). In other examples, the control PCB 172 may alternatively or additionally include a communication circuit for wired communications.

The enclosure 140 may comprise a body 141 having a rear wall 142 and a side wall 144. The rear wall 142 of the body 141 may be oriented parallel to the rear wall 132 of the body 131 of the heat sink 130 and parallel to the plane formed by the diffuser 118 and parallel to the plane formed by the bezel 116 of the trim ring 112 of the trim portion 110 (e.g., located in a plane extending in the longitudinal direction L and the lateral direction A). The side wall 144 of the body 141 may extend approximately perpendicular from the rear wall 142 (e.g., in the transverse direction T). The enclosure 140 (e.g., the rear wall 142 and the side wall 144) may comprise (e.g., define) a cavity 145 in which the control PCB assembly 170 may be received (e.g., as shown in FIGS. 2 and 6). The body 141 of the enclosure 140 may be made from, for example, a non-conductive material (e.g., such as plastic). In some examples, the body 141 of the enclosure 140 may be made from a conductive material (e.g., such as metal). For example, the body 141 (e.g., the side wall 144) may be cylindrical in shape, such that the side wall 144 comprises a single cylindrical portion (e.g., as shown in FIG. 2). In some examples, the body 141 may be rectangular in shape (e.g., the body 141 may comprise four substantially planar portions connected to the rear wall 142 to form the cavity 145) or octagonal in shape (e.g., the body 141 may comprise eight substantially planar portions connected to the rear wall 142 to form the cavity 145). The heat sink 130 may be mounted to the enclosure 140 via fasteners 106 (e.g., screws) received through openings 169 in the heat sink 130 (e.g., in the rear wall 132) and openings 143 in bosses 146 of the enclosure 140 (e.g., as shown in FIGS. 2, 4, and 5).

The mounting bracket 180 may allow the lighting device 100 to be mounted to the downlight housing installed in the building structure. The mounting bracket 180 may comprise friction wings 182 (e.g., two friction wings although additional or fewer wings, such as one continuous wing, may be used) that may be connected together via a support bar 184. The friction wings 182 may each comprise a respective tab 183 that may be oriented perpendicular to the respective friction wing 182. The support bar 184 may comprise feet 185 (e.g., two feet) that may abut against the friction wings 182. The tabs 183 of the friction wings 182 may extend through respective slots 186 in the support bar 184 adjacent to the respective feet 185. The friction wings 182 may be attached to the support bar 184 via respective fasteners 108 received through respective openings 187 in support bar 184 and respective openings 188 in the tabs 183 of the friction wings 182 (e.g., as shown in FIG. 6). In addition, the mounting bracket 180 may be attached to the heat sink 130 via the fasteners 108 received through respective openings 189 in the rear wall 132 of the body 131 of the heat sink 130. When the mounting bracket 180 is attached to the heat sink 130 and the heat sink 130 is attached to the enclosure 140, the support bar 184 may extend through notches 148 in the side wall 144 of the body 141 of the enclosure 140 (e.g., as shown in FIGS. 2 and 6). For example, when the lighting device 100 is mounted to the downlight housing installed in the building structure, the friction wings 182 may contact a side wall of the downlight housing and flex to provide a friction fit with the downlight housing.

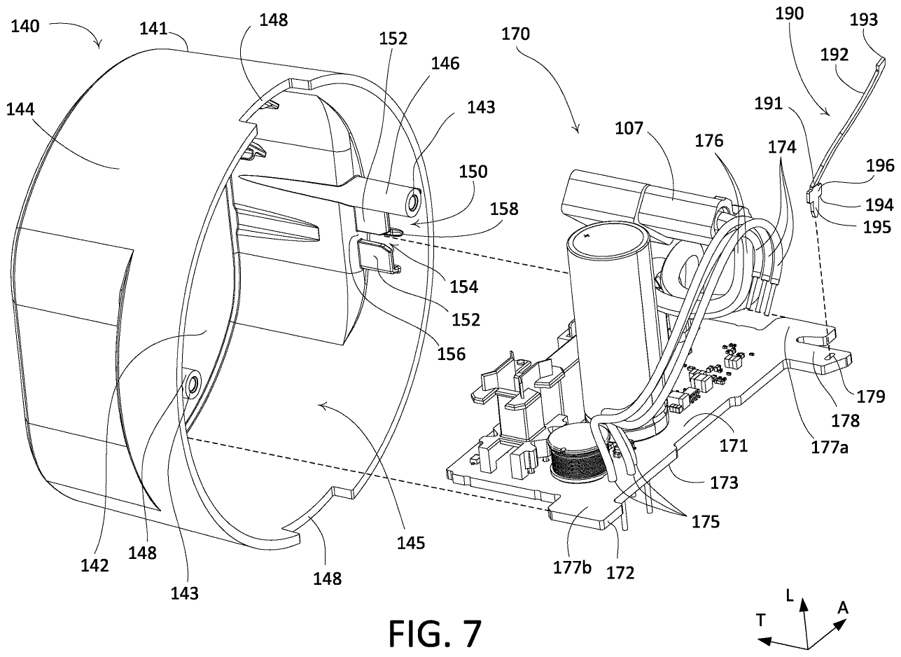

FIG. 7 is an enlarged exploded view of the enclosure 140 and the control PCB assembly 170. The control PCB 172 may be received within the cavity 145 of the enclosure (e.g., as shown in FIGS. 6 and 7) and be supported by the side wall 144 of the enclosure 140 within the cavity 145 (e.g., as shown in FIG. 6). The plane of the control PCB 172 may be oriented perpendicular to the rear wall 142 of the body 141 of the enclosure 140, the rear wall 132 of the body 131 of the heat sink 130, and the plane of the emitter PCB 162 of the emitter PCB assembly 160 (e.g., located in a plane extending in the lateral direction A and the transverse direction T as shown in FIG. 6).

The enclosure 140 may comprise support structures 150 (e.g., two support structures) located within the cavity 145 of the enclosure 140 for supporting the control PCB 172 (e.g., as shown in FIG. 7). For example, the support structures 150 may be located on opposing sides of the side wall 144 (e.g., on opposing sides of the cavity 145). The control PCB 172 may comprise first and second attachment tabs 177a, 177b that may engage the support structures 150 of the enclosure 140 for supporting the control PCB 172 within the cavity 145 of the enclosure 140. For example, the first and second attachment tabs 177a, 177b may be located on opposing edges of the control PCB 172. While only one of the support structures 150 (e.g., a first one of the support structures 150 for receiving the first attachment tab 177a of the control PCB 172) is shown in FIG. 7, the enclosure 140 (e.g., the side wall 144) may comprise a corresponding support structure (e.g., a second one of the support structures 150 for receiving the second attachment tab 177b of the control PCB 170) on the opposite side of the enclosure 140. For example, the second one of the support structures 150 may be identical and/or a mirror image of the first one of the support structures 150 shown in FIG. 7.

The support structures 150 may each be formed as part of the enclosure 140 (e.g., the side wall 144). Each of the support structures 150 may comprise base portions 152 (e.g., two base portions) and may comprise a respective channel 154. The base portions 152 may be spaced apart from each other to form the respective channel 154. For example, each of the base portions 152 may be substantially planar members (e.g., located in a plane extending in the longitudinal direction L and the transverse direction T as shown in FIG. 7). The first and second attachment tabs 177a, 177b of the control PCB 172 may be received within the channels 154 of the respective support structures 150 (e.g., in the transverse direction T as shown in FIG. 7). The channels 154 of the support structures 150 may maintain alignment of the control PCB 172 in the longitudinal direction L when the first and second attachment tabs 177a, 177b of the control PCB 172 are received in the respective channels 154. Each of the support structures 150 may further comprise a respective ledge portion 156 and a respective rib 158 extending from the side wall 144 (e.g., in the lateral direction A). When the first and second attachment tabs 177a, 177b of the control PCB 172 are received in the channels 154, the ledge portions 156 of the respective support structures 150 may abut a respective first edge of the first and second attachment tab 177a, 177b of the control PCB 172 to maintain alignment of the control PCB 172 in the transverse direction T (e.g., between the respective ledge portion 156 and the rear wall 132 of the heat sink 130). In addition, when the first and second attachment tabs 177a, 177b of the control PCB 172 are received in the channels 154, the ribs 158 of the respective support structures 150 may abut a respective second edge (e.g., opposing the first edge) of the first and second attachment tab 177a, 177b of the control PCB 172 to maintain alignment of the control PCB 172 in the lateral direction A. In some examples, the control PCB 172 may abut the rear wall 142 of the enclosure 140 when the first and second attachment tabs 177a, 177b of the control PCB 172 are received in the channels 154 of the respective support structures 150 and the respective first and second attachment tabs 177a, 177b of the control PCB 172 are abutting the respective ledge portions 156. Other configurations and structures are possible to orient the control PCB 172 in the perpendicular orientations as shown in FIGS. 6 and 7.

The control PCB 172 may be electrically coupled to the emitter PCB 162 via one or more electrical conductors, such as wires 174 (e.g., three wires). For example, the wires 174 may be received through and soldered to respective through-holes 175 in the control PCB 172, such that the wires 174 are electrically connected to the electrical circuitry of the control PCB assembly 170. The wires 174 may extend through an opening 168 in the heat sink 130 (e.g., the rear wall 132) and may be connected to respective connectors 166 mounted to the emitter PCB 162 (e.g., as shown in FIG. 5) thereby electrically connecting the electrical circuitry of the control PCB assembly 170 to the emitters 164 of the emitter PCB assembly 160. The control PCB assembly 170 may further comprise a connector 107 electrically coupled to the control PCB 172 via one or more electrical conductors, such as wires 176 (e.g., two wires). The connector 107 may extend through an opening (not shown) in the rear wall 142 of the body 141 of the enclosure 140. The connector 107 may allow the lighting device 100 (e.g., the control PCB assembly 170) to be electrically connected to the power source for receiving power.

The lighting device 100 (e.g., the control PCB assembly 170) may further comprise an antenna 190, which may allow the one or more wireless communication circuits mounted to the control PCB 172 to transmit and/or receive RF signals. The control PCB 172 may comprise an extension 178 (e.g., an extended portion) to which the antenna 190 may be coupled (e.g., mechanically and electrically coupled). The extension 178 may extend through an opening 159 in the rear wall 132 of the heat sink 130, such that the antenna 190 may extend from the extension 178 within the recess 135 of the heat sink 130. For example, the opening 159 in the rear wall 132 of the heat sink 130 may be offset from the axis 105 of the lighting device 100 (e.g., from a center of the rear wall 132 of the heat sink 130, such that the antenna 190 may be located between the reflector 120 (e.g., the outer surface 128) and the heat sink 130 (e.g., the side wall 134). The antenna 190 may extend from the extension 178 of the control PCB 170 between the reflector 120 (e.g., the outer surface 128) and the heat sink 130 (e.g., the side wall 134).

The antenna 190 may comprise an arm 192 and a base 194. The arm 192 may extend from a first end 191 (e.g., a first antenna end) at the base 194 to a second end 193 (e.g., a second antenna end) that is distal from the first end 191. For example, the antenna 190 may comprise a formed piece of conductive material, such as metal. The base 194 may be mechanically coupled (e.g., connected) to the extension 172 of the control PCB 172 and electrically coupled to the one or more wireless communication circuits mounted to the control PCB 172 (e.g., for electrically coupling the antenna 190 to the one or more wireless communication circuits mounted to the control PCB 172). For example, the base 194 may comprise a lead portion 195 and an enlarged portion 196 connected to the lead portion 195. The lead portion 195 may extend through an opening 179 in the extension 178 of the control PCB 172 (e.g., as shown in FIGS. 4 and 7) for mechanically coupling the antenna 190 to the extension 178 and electrically coupling the antenna 190 to the one or more wireless communication circuits mounted to the control PCB 172. For example, the lead portion 195 may be planar and the opening 179 may comprise a slot that may receive the lead portion 195. The enlarged portion 196 of the base 194 may not extend into the opening 179 in the extension 178 of the control PCB 172. The enlarged portion 196 of the base 194 may contact the extension 178 of the control PCB 172 when the lead portion 195 is received in the opening 179, e.g., for orienting the antenna 190 (e.g., the arm 192) relative to the control PCB 172. For example, the opening 179 may be a plated through-hole, such that the base 194 of the antenna 190 (e.g., the lead portion 195) may be soldered to the plated though-hole for mechanically connecting the antenna 190 to the control PCB 172 and electrically connecting the antenna 190 to the one or more wireless communication circuits mounted to the control PCB 172. The solder connection between the lead portion 195 and the opening 179 may form a junction between the control PCB 172 and the antenna 190. In some examples, the base 194 of the antenna 190 may be electrically connected (e.g., soldered) to an electrical pad (not shown) on the extension 178 of the control PCB 172 (e.g., without the lead portion 195 extending through the opening 179) for electrically coupling the antenna 190 to the one or more wireless communication circuits mounted to the control PCB 172.

The arm 192 of the antenna 190 may extend from the base 194 (e.g., from the extension 178 of the control PCB 172) towards the aperture 115 of the trim portion 110 when the lighting device 100 is assembled. The arm 192 of the antenna 190 may comprise, for example, a strip of metal having a width W_{ANT1} (e.g., as shown in FIG. 3) and a thickness T_{ANT1} (e.g., as shown in FIG. 6). For example, the width W_{ANT1} of the arm 192 may be approximately 0.06 inches and the thickness TANTI of the arm 192 may be approximately 0.02 inches. The arm 192 of the antenna 190 may be, for example, substantially planar (e.g., as shown in FIG. 6), and the arm 192 (e.g., a plane of the arm 192) may extend at an angle from the base 194. For example, the arm 192 (e.g., the plane of the arm)may extend from the base 194 at an angle O_{ANT1} relative to the to the rear wall 132 of the body 131 of the heat sink 130 and the plane of the diffuser 118 of the trim portion 110 (e.g., relative to a plane extending in the longitudinal direction L and the lateral direction A) as shown in FIG. 6.

The arm 192 of the antenna 190 may curve around the reflector 120 between the reflector 120 (e.g., the outer surface 128) and the heat sink 130 (e.g., the side wall 134). The arm 192 of the antenna 190 may comprise a first portion 197, a second portion 198, and a third portion 199 (e.g., as shown in FIG. 5). The first portion 197 of the arm 192 may extend (e.g., extend linearly) in the longitudinal direction L from the base 194 towards the reflector 120 and the aperture 115 of the trim portion 110 (e.g., as shown in FIGS. 3 and 5). The second portion 198 of the arm 192 may continue to extend from the first portion 197 towards the aperture 115 of the trim portion 110. For example, the second portion 198 of the arm 192 may be curved (e.g., slightly curved) away from the reflector 120 (e.g., the outer surface 128) and towards the heat sink 130 (e.g., the side wall 134). The third portion 199 of the arm 192 may continue to extend from the second portion 198 towards the aperture 115 of the trim portion 110. For example, the third portion 199 of the arm 192 may be curved away from the heat sink 130 (e.g., the side wall 134) as the arm 192 nears the side wall 134 to avoid contacting the side wall 134 of the heat sink (e.g., since the heat sink 130 may be made of a conductive material). The antenna 190 may be characterized by a length L_{ANT1} from the junction between the control PCB 172 and the antenna 190 to the second end 193 of the antenna 190 (e.g., a total length of the enlarged portion 196 of the base 194, the first portion 197 of the arm 192, the second portion 198 of the arm 192, and the third portion 199 of the arm 192). For example, the length LANTI of the antenna 190 from the junction between the control PCB 172 and the antenna 190 to the second end 193 of the antenna 190 may be approximately 1.2 to 1.3 inches (e.g., when the communication frequency_{COMM} of the wireless communication circuit of the control PCB assembly 170 is approximately 2.4 GHz).

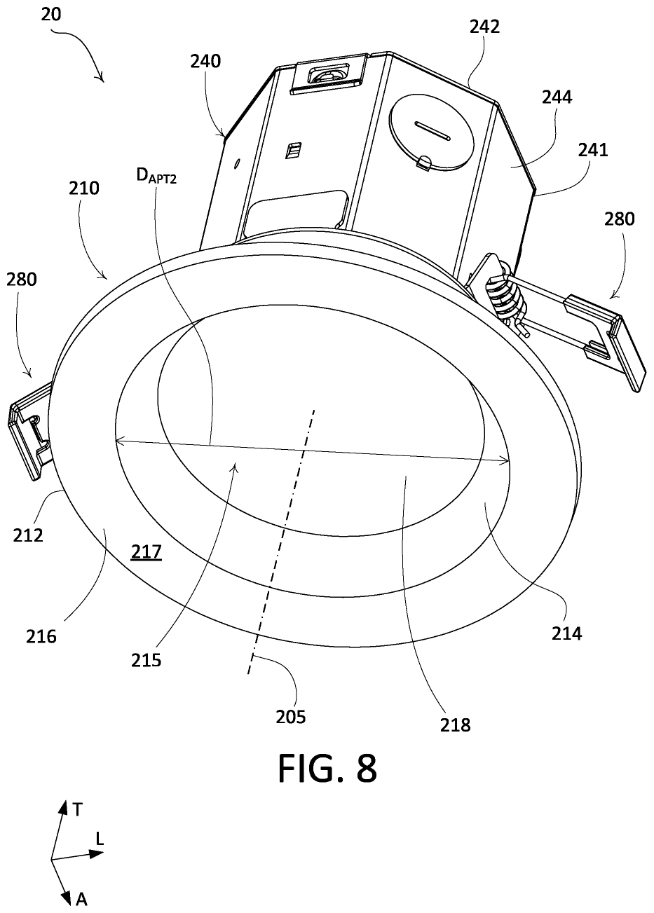

FIGS. 8-15 depict another example illumination device, such as a lighting device 200 (e.g., a controllable lighting device). The lighting device 200 may be configured to be installed within a building structure (e.g., such as a ceiling, ceiling tile, etc.), for example, as part of a new and/or remodel installation. The building structure (e.g., the ceiling) in which the downlight housing may be installed may be located in a plane that extends in a longitudinal direction L and a lateral direction A. The lighting device 200 may be configured to be electrically coupled to a power source, such as an alternating-current (AC) power source and/or a direct-current (DC) power source.

FIG. 8 is a bottom perspective view of the lighting device 200. The lighting device 200 may comprise a trim portion 210 that includes a trim ring 212 having a sleeve 214, a bezel 216 (e.g., a flange), and a bottom surface 217 (e.g., a bottom surface of the bezel 216). The trim portion 210 (e.g., the trim ring 212) may comprise (e.g., define) an aperture 215 through which the lighting device 200 may be configured to emit light (e.g., as will be described in greater detail below). For example, the aperture 215 may have a circular shape (e.g., may be a circle). The aperture 215 may be located in a plane that extends in the longitudinal direction L and the lateral direction A at the bottom surface 217 of the trim ring 212. For example, the aperture 215 may be characterized by a diameter D_{APT2} (e.g., approximately 4-6 inches).

The trim portion 210 may further comprise a diffuser 218 (e.g., a lens). The diffuser 218 may be transparent or translucent, and may be made of any suitable material, for example plastic or glass. The diffuser 218 may cover the aperture 215 of the trim portion 210, such that the light emitted by the lighting device 200 may be transmitted through the diffuser 218. For example, the diffuser 218 may diffuse (e.g., scatter) the light transmitted through the aperture 215.

The diffuser 218 may be located in a plane that extends in the longitudinal direction L and the lateral direction A. The lighting device 200 may define an axis 205 (e.g., a central axis) that extends through a center of the trim portion 210 (e.g., the trim ring 212 and/or the aperture 215) in a transverse direction T.

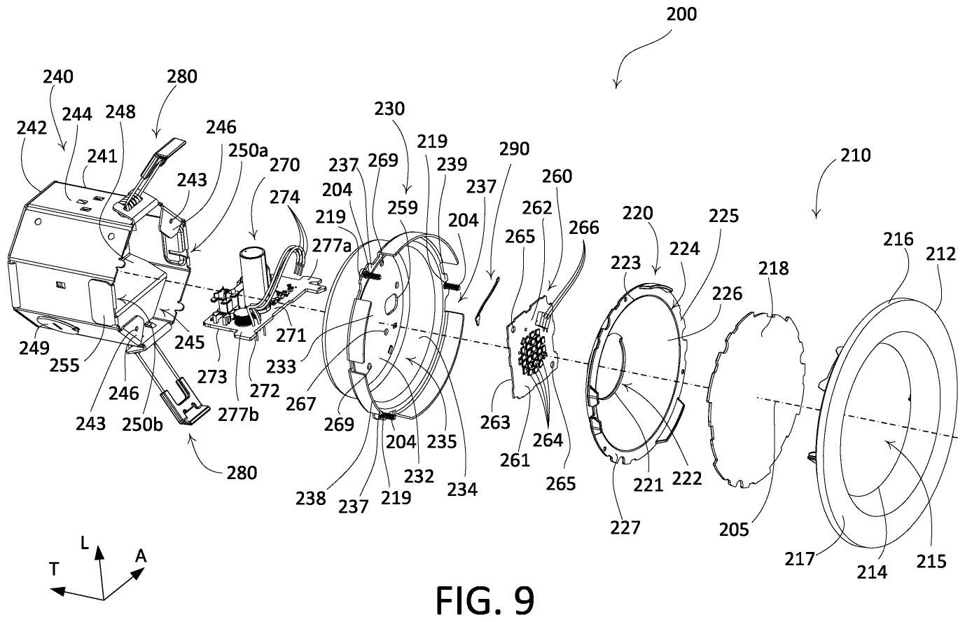

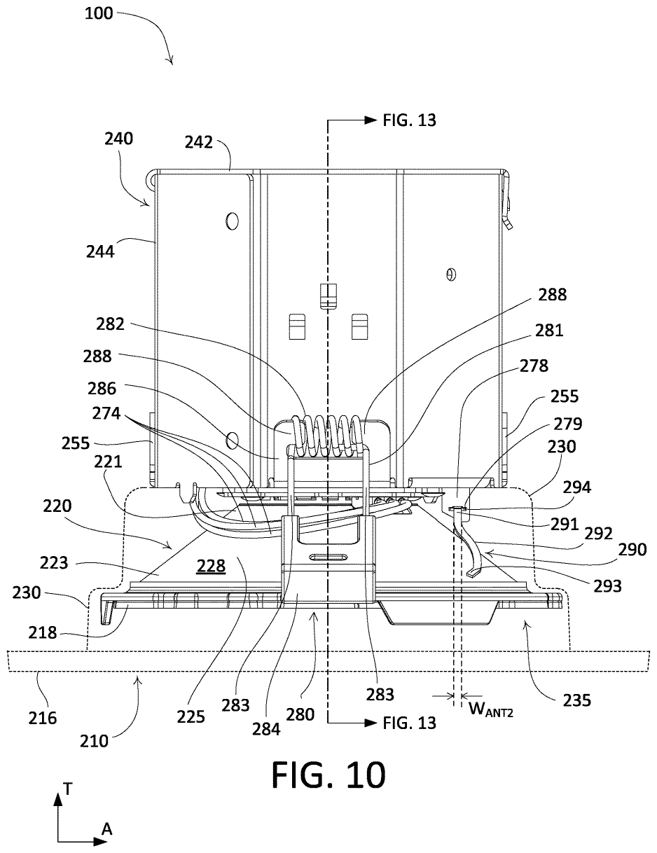

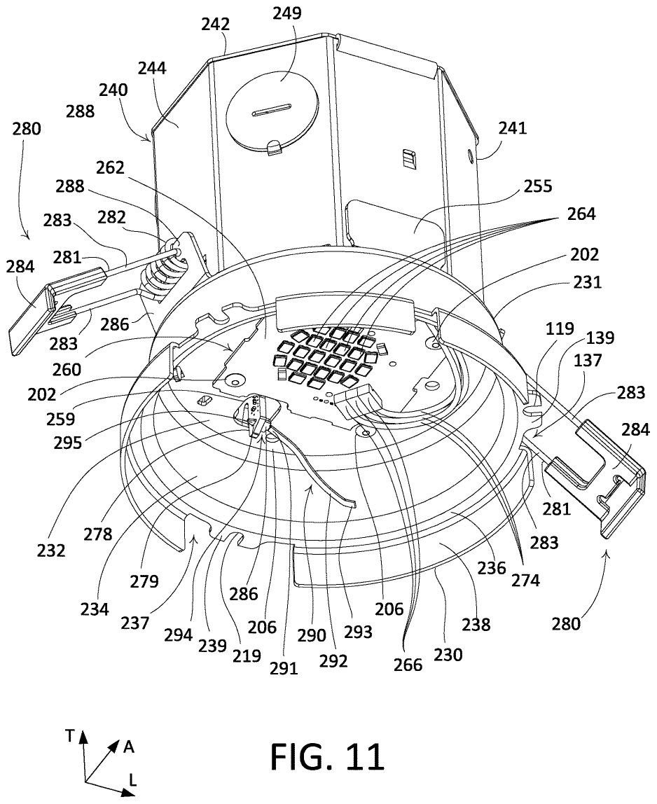

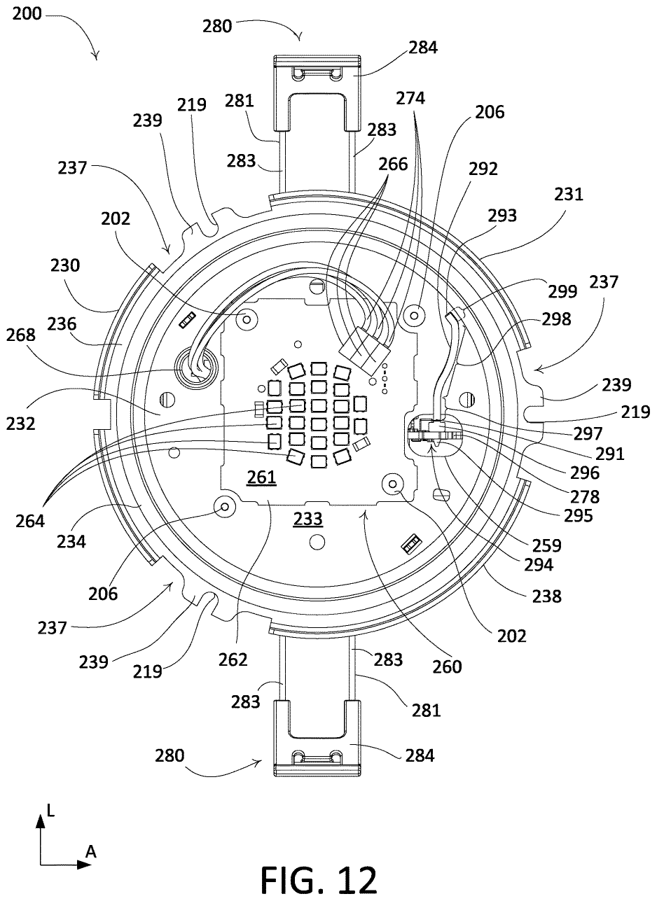

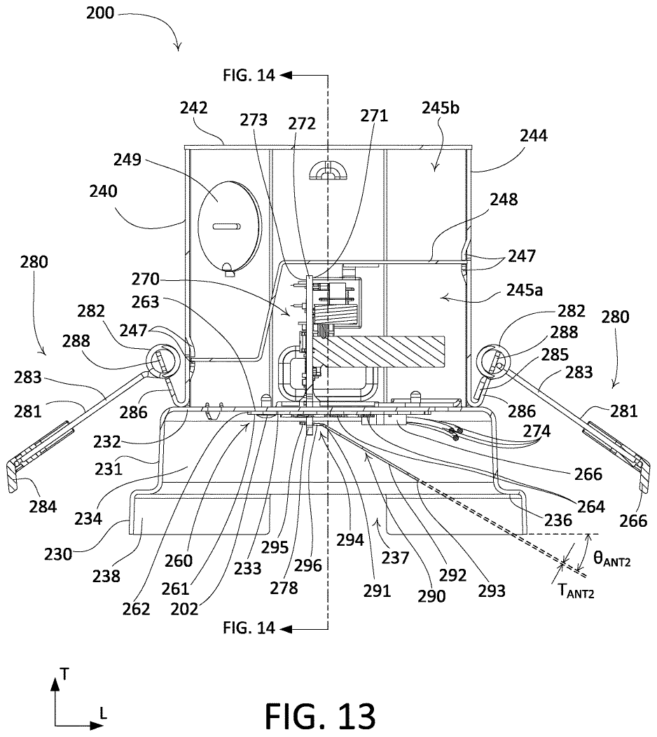

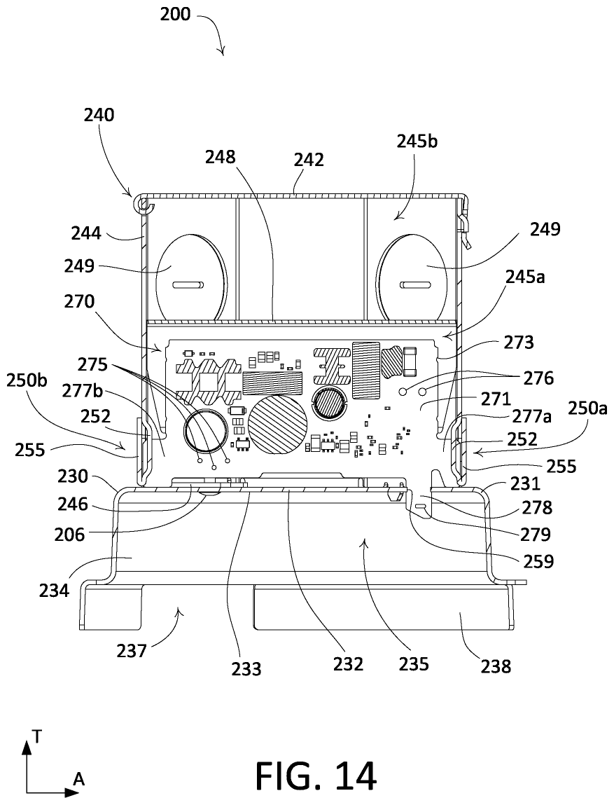

FIG. 9 is an exploded view of the lighting device 200. The lighting device 200 may further comprise a reflector 220, a heat sink 230, an enclosure 240 (e.g., a rear enclosure), an emitter printed circuit board (PCB) assembly 260 (e.g., a first PCB assembly), and a control printed circuit board (PCB) assembly 270 (e.g., a second PCB assembly). FIG. 10 is a side view of the lighting device 200 with the trim portion 210, the reflector 220, and the heat sink 230 removed. The location of the trim portion 210 (e.g., the bezel 216 of the trim ring 212) and the heat sink 230 are shown by dashed lines in FIG. 10. FIG. 11 is a bottom perspective view and FIG. 12 is a bottom view of the lighting device 200 with the trim portion 210 and the reflector 220 removed. FIG. 13 is a side cross-section view of the lighting device 200 with the trim portion 210 and the reflector 220 removed (e.g., taken through the line shown in FIG. 10). FIG. 14 is a side cross-section view of the lighting device 200 with the trim portion 210 and the reflector 220 removed (e.g., taken through the line shown in FIG. 13).

The emitter PCB assembly 260 may comprise an emitter printed circuit board (PCB) 262 (e.g., a first PCB). The emitter PCB 262 may have a first side 261 (e.g., a front side) and a second side 263 (e.g., a rear side) that is opposed to the first side 261. The emitter PCB assembly 260 may comprise a plurality of emitters 264 (e.g., emission light-emitting diodes) mounted to the emitter PCB 262 (e.g., to the first side 261 of the emitter PCB 262). For example, the emitter PCB assembly 260 may comprise 24 emitters 264 (e.g., as shown in FIGS. 9, 11 and 12). In some examples, the emitter PCB assembly 260 may include more or less emitters 264 than shown in FIGS. 9, 11 and 12. The emitter PCB assembly 260 may include multiple “chains” of the emitters 264 (e.g., series-coupled emitters). The emitters 264 of each chain may be coupled in series and may conduct the same drive current. Each chain may include emitters 264 that produce illumination at the same peak emission wavelength (e.g., emit light of the same color) and/or the same color temperature. The emitters 264 of different chains may emit light of different colors and/or color temperatures. For example, the emitter PCB assembly 260 may comprise two chains each of emitters 264 (e.g., 12 emitters) that are configured to emit light at respective different color temperatures (e.g., a warm-white color temperature and a cool-white color temperature). The individual emitters 264 in each chain may be scattered about the emitter PCB 262 to improve color mixing within the emitter PCB assembly 260. Other variations of numbers of the emitters 264 in each chain, the colors and/or color temperatures of the emitters 264, the numbers of the colors and/or color temperatures of the emitters 264, the number of chains of the emitters 264, the number of chains that emit light of a same color, etc., may be used. Other variations are possible.

The heat sink 230 may comprise a body 231 having a rear wall 232 (e.g., a plate portion) and a side wall 234. The rear wall 232 of the body 131 may be oriented parallel to the diffuser 218 of the trim portion 210 (e.g., in a plane extending in the longitudinal direction L and the lateral direction A). The side wall 234 of the body 231 may extend approximately perpendicular from the rear wall 232 (e.g., in the transverse direction T). The heat sink 230 (e.g., the rear wall 232 and the side wall 234) may comprise (e.g., define) a recess 235 (e.g., a cavity) in which the emitter PCB assembly 260 may be received. For example, the body 231 (e.g., the side wall 234) may be cylindrical in shape. In some examples, the body 231 may be rectangular in shape (e.g., the body 231 may comprise four side walls connected to the rear wall 232 to form the recess 235). The emitter PCB 262 of the emitter PCB assembly 260 (e.g., the second side 263) may be mounted to a mounting surface 233 on the rear wall 232 of the heat sink 230. The emitters 264 of the emitter PCB assembly 260 may be thermally coupled to the heat sink 230 via the emitter PCB 262. The heat sink 230 (e.g., the body 231) may dissipate heat generated by the emitters 264 of the emitter PCB assembly 260. For example, the heat sink 230 (e.g., the body 231) may be made from a thermally-conductive material, such as metal (e.g., aluminum). A thermally-conductive substance may be disposed between the emitter PCB 262 and the heat sink 230. The emitter PCB assembly 260 may be attached to the heat sink 230 (e.g., the rear wall 232) via fasteners 202 (e.g., screws) received through openings 265 in the emitter PCB 262 and openings 267 in the heat sink 230 (e.g., in the rear wall 232).

The body 231 of the heat sink 230 may comprise a ledge portion 236 extending from the extending from the side wall 234 (e.g., in a plane extending in the longitudinal direction L and the lateral direction A) and a rim portion 138 extending from the ledge portion 236 (e.g., perpendicular to the ledge portion 236). For example, an opening formed by the rim portion 238 may be characterized by a larger diameter than a diameter of the opening formed by the side wall 234. The rim portion 238 may comprise gaps 237 spaced around a perimeter (e.g., a circumference) of the side wall 234 (e.g., and around a perimeter of the rim portion 238). The body 231 of the heat sink 230 may further comprise tabs 239 extending radially from the side wall 234 and positioned in the gaps 237 of the rim portion 238 (e.g., in a plane extending in the longitudinal direction L and the lateral direction A). The rim portion 238 may comprise, for example, three of the gaps 237 having the tabs 239 positioned within them (e.g., as shown in FIGS. 9, 11, and 12) although fewer or additional of the gaps 237 having the tabs 139 may be used) The trim portion 210 (e.g., the trim ring 212) may couple (e.g., mount) to the heat sink 230, for example, with the sleeve 214 of the trim ring 212 received in the recess 235 of the heat sink 230.

For example, the heat sink 230 may be attached to the trim portion 210 (e.g., the trim ring 212) via respective fasteners 204 (e.g., three fasteners) received through respective slots 219 in the tabs 239 of the body 231 of the heat sink 230 (e.g., as shown in FIG. 2) and respective openings (not shown) in the trim ring 212. The trim ring 212 may include respect extensions (e.g., three extensions) that include the respective openings where the extensions fit or mate within each of the gaps 237 thereby aligning the slots 219 in the tabs 239 of the body 231 with the openings (not shown) in the trim ring 212.

The reflector 220 may comprise a body 225 (e.g., a conically-shaped body) having a first opening 222 at a first end 221 (e.g., a first reflector end) of the reflector 220 and a second opening 224 at a second end 223 (e.g., a second reflector end) of the reflector 220 (e.g., as shown in FIG. 9). The body 225 of the reflector 220 may include an inner surface 226 and an outer surface 228. The body 225 of the reflector 220 may further comprise a flange 227 surrounding the second opening 224 at the second end 223. The reflector 220 may be centered about the axis 205 of the lighting device 200 (e.g., the axis 205 may extend through the center of the first opening 222 and/or the second opening 224 of the reflector 220). The trim ring 212 of the trim portion 210 may attach to the heat sink 230 with the diffuser 218 and the reflector 220 (e.g., the flange 227 of the body 225 of the reflector 220) captured between the heat sink 230 (e.g., the side wall 234) and the trim ring 212 (e.g., the sleeve 214). The flange 227 (e.g., a top side of the flange 227) of the reflector 220 may be configured to rest on the ledge portion 236 of the heat sink 230. The lens 218 may be captured between the flange 227 (e.g., a bottom side opposite the top side of the flange 227) of the reflector 220 and the extensions of the trim ring 212. When the trim ring 212 is attached to the heat 230, the body 225 of the reflector 220 may extend into the recess 235 of the heat sink 230 (e.g., as shown in FIG. 10). The reflector 220 may be made from, for example, a non-conductive material (e.g., such as plastic). For example, the inner surface 226 of the reflector 220 may be a reflective surface (e.g., a white surface). When the reflector 220 is captured between the trim ring 212 and the heat sink 230, the first opening 222 of the reflector 220 may be centered over the emitters 264 on the emitter PCB 262, such that the emitters 264 may emit light through the first opening 222 of the reflector 220. The reflector 220 (e.g. the inner surface 226) may reflect light emitted by the emitters 264 through the second opening 224 of the reflector 220, the diffuser 218, and the aperture 215 of the trim portion 210.

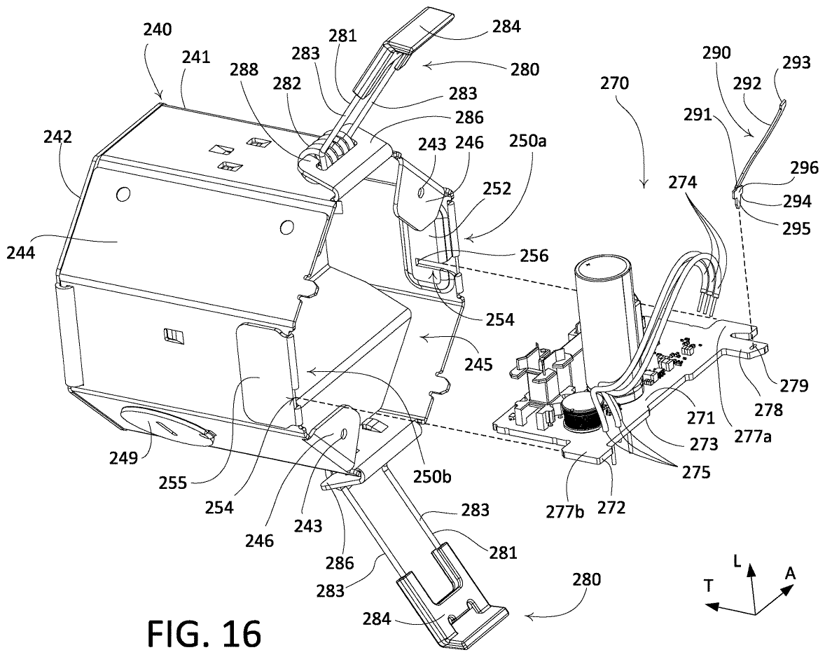

The control PCB assembly 270 may comprise a control printed circuit board (PCB) 272 (e.g., a second PCB). The control PCB 272 may have a first side 271 and a second side 273 opposing the first side 271. The control PCB 272 may have mounted thereto electrical circuitry including one or more drive circuits for controlling the amount of power delivered to the emitters 264 of the emitter PCB assembly 260, one or more control circuits for controlling the drive circuits, and one or more wireless communication circuits for communicating wireless signals (e.g., radio-frequency (RF) signals) with external devices. For example, the wireless communication circuit of the control PCB assembly 270 may be configured to communicate the wireless signals at a communication frequency f_{COMM} (e.g., approximately 2.4 GHz). In other examples, the control PCB 272 may alternatively or additionally include a communication circuit for wired communications The enclosure 240 may comprise a body 241 having a rear wall 242 (e.g., a plate portion) and a side wall 244. The rear wall 242 of the body 241 may be oriented parallel to the rear wall 232 of the body 231 of the heat sink 230 and parallel to the plane formed by the diffuser 218 and parallel to the plane formed by the bezel 216 of the trim ring 212 of the trim portion 210 (e.g., located in a plane extending in the longitudinal direction L and the lateral direction A). The side wall 244 of the body 241 may extend approximately perpendicular from the rear wall 242 (e.g., in the transverse direction T). The enclosure 240 (e.g., the rear wall 242 and the side wall 244) may comprise (e.g., define) a cavity 245 (e.g., as shown in FIGS. 9 and 16). The body 241 of the enclosure 240 may be made from, for example, a conductive material (e.g., such as metal). In some examples, the body 241 of the enclosure 240 may be made from a non-conductive material (e.g., such as plastic). For example, the body 241 (e.g., the side wall 244) may be octagonal in shape, such that the side wall 244 comprises eight substantially planar portions (e.g., as shown in FIG. 9). In some examples, the body 241 may be rectangular in shape (e.g., the body 241 may comprise four substantially planar portions connected to the rear wall 242 to form the cavity 245) or cylindrical in shape (e.g., the body 241 may comprise a single cylindrical portion connected to the rear wall 242 to form the cavity 245 similar to the body 141 of the enclosure 140 shown in FIG. 2).

The enclosure 240 may further comprise tabs 246 (e.g., two tabs although additional or fewer tabs may be used) extending inward towards the cavity 245 from the side wall 244. For example, the tabs 246 may be oriented perpendicular to the side wall 244 (e.g., located in a plane extending in the longitudinal direction L and the lateral direction A). The heat sink 230 may be mounted to the enclosure 240 via fasteners 206 (e.g., screws) received through openings 269 in the heat sink 230 (e.g., the rear wall 232) and openings 243 in the tabs 246 of the enclosure 240 (e.g., as shown in FIGS. 9, 11, and 12). The enclosure 240 may comprise a barrier 248 that is located within the cavity 245 that is formed by the rear wall 242 and the side wall 244 (e.g., as shown in FIG. 9), such that the cavity 245 is split into a first cavity portion 245a and a second cavity portion 245b (e.g., as shown in FIGS. 13 and 14). The barrier 248 may be held in place by clasps 247 formed in the side wall 244 (e.g., as shown in FIG. 13). The barrier 248 may be made of a conductive material (e.g., such as metal) or a non-conductive material (e.g., such as plastic). The control PCB 272 may be received within the first cavity portion 245a (e.g., as shown in FIGS. 13 and 14).

The enclosure 240 may further comprise spring clips 280 (e.g., two spring clips although additional or fewer spring clips may be used) that may mount the lighting device 200 to the building structure (e.g., the ceiling). Each of the spring clips 280 may comprise a spring member 281 (e.g., a wire). The spring member 281 of each of the spring clips 280 may be formed such that the spring member 281 comprises a coil spring portion 282 and two elongated portions 283 that extend from the coil spring portion 282 portion to a contact member 284 (e.g., as shown in FIGS. 10, 13, and 15). For example, the spring member 281 of each of the spring clips 280 may extend through the contact member 284 between the two elongated portions 283, such that the spring member 281 may be a single wire. In some examples, the spring member 281 may be formed from two wires. Each of the spring clips 280 (e.g., the coil spring portion 282 of the respective spring member 281) may be coupled to a respective wing 286 an external surface of on the enclosure 240. For example, the wings 286 may each comprise projections 288 (e.g., two projections) that may be received in the coil spring portion 282 (e.g., into a center of the coil spring portion 282) of the spring member 281 of the respective spring clip 280 (e.g., as shown in FIGS. 10, 13, and 15) thereby moveably/rotatably connecting the spring clips to the enclosure 240. The coil spring portion 282 of the respective spring member 281 of each of the spring clips 280 may comprise a tang 285 that may be located between the respective wing 286 and the side wall 244 of the enclosure 240 (e.g., as shown in FIG. 13). The tang 285 of each of the coil spring portions 282 may contact the respective wing 286 to bias the spring clips 280 in a downward direction (e.g., as shown in FIG. 13). For example, when the lighting device 200 is mounted to the building structure, the spring clips 280 (e.g., the contact members 284) may contact an upper surface of the ceiling and the bezel 216 of the trim ring 212 (e.g., a surface of the bezel 216 opposite the bottom surface 217) of the trim portion 210 may contact a lower surface of the ceiling, such that the ceiling is captured between the spring arms 280 and the trim portion 210. When inserting the lighting device 200 into the building structure (e.g., ceiling), the spring clips 280 may be retracted upwards to contact the enclosure 240. Once clearing the ceiling, for example, the spring clips 280 may spring back into place contacting an upper surface of the ceiling.

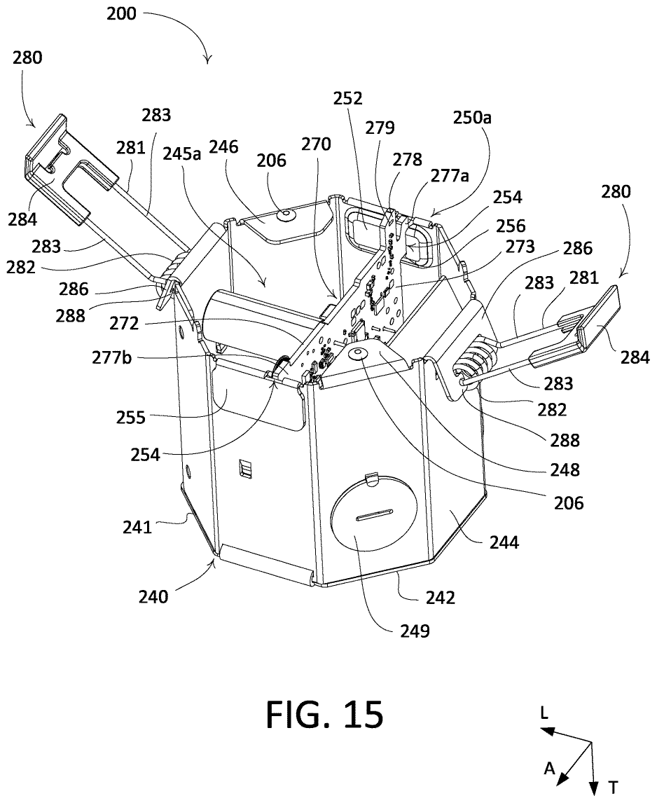

FIG. 15 is a perspective view of the lighting device 200 showing the control PCB assembly 270 installed in the cavity 245 (e.g., first cavity portion 245a) of the enclosure 240 (e.g., with the trim portion 210, the reflector 220, and the heat sink 230 removed). FIG. 16 is an enlarged exploded view of the enclosure 240 and the control PCB assembly 270. The plane of the control PCB 272 may be supported by the side wall 244 of the enclosure 240 within the first cavity portion 245a (e.g., as shown in FIG. 13-15). The plane of the control PCB 272 may be oriented perpendicular to the rear wall 242 of the body 241 of the enclosure 240, the rear wall 232 of the body 231 of the heat sink 230, and the emitter PCB 262 of the emitter PCB assembly 260 (e.g., located in a plane extending in the lateral direction A and the transverse direction T as shown in FIGS. 13 and 14).

The enclosure 240 may comprise first and second support structures 250a, 250b located within the cavity 245 of the enclosure 240 for supporting the control PCB 272 (e.g., as shown in FIGS. 14-16). For example, the support structures 250a, 250b may be located on opposing sides of the side wall 244 (e.g., on opposing sides of the cavity 245 and/or the first cavity portion 245a). The control PCB 272 may comprise first and second attachment tabs 277a, 277b that may engage the first and second support structures 250a, 250b of the enclosure 240, respectively for supporting the control PCB 272 within the cavity 245 (e.g., the first cavity portion 245a) of the enclosure 240 (e.g., as shown in FIGS. 14 and 15). For example, the first and second attachment tabs 277a, 277b may be located on opposing edges of the control PCB 272. The first and second support structures 250a, 250b of the enclosure 240 may be located on opposite sides of the enclosure 240 for receiving the first and second attachment tabs 277a, 277b of the control PCB 272, respectively. While only one the first support structure 250a is shown in detail in FIG. 16, the second support structure 250b may be identical and/or a mirror image of the first support structure 250a. Since the enclosure 240 may be made of a conductive material, the control PCB 272 may have keep-out regions between electrical traces and/or pads on the control PCB 272 and the points of contact between the control PCB 272 and the first and second support structures 250a, 250b. The keep-out regions of the control PCB 272 may not include any electrical traces and/or pads. In some examples, the first and second attachment tabs 277a, 277b of the control PCB 272 may not include any electrical traces and/or pads.

The first and second support structures 250a, 250b may each be formed as part of the enclosure 240 (e.g., the side wall 244). Each of the first and second support structures 250a, 250b may comprise a protruding portion 252 of the enclosure 240 that extends into the cavity 245 (e.g., the first cavity portion 245a) of the enclosure 240. Each of the first and second support structures 250a, 250b (e.g., the respective protruding portion 252) may comprise a respective channel 254. For example, the respective protruding portions 252 of the first and second support structures 250a, 250b may be stamped into the enclosure 240 (e.g., the side wall 244) and the respective channels 254 may be cut into the respective protruding portions 252. Each of the first and second support structures 250a, 250b may further comprise a respective flap 255 that may extend from the side wall 244, fold over outside of the cavity 245 (e.g., the first cavity portion 245a), and abut the side wall 244 to cover the respective protruding portion 252 and the respective channel 254.

Each of the first and second attachment tabs 277a, 277b of the control PCB 272 may be received within the channels 254 of the respective support structures 250a, 250b (e.g., in the transverse direction T as shown in FIG. 16) until the first and second attachment tabs 277a, 277b abut end surfaces 256 of the respective channels 154. When the first and second attachment tabs 277a, 277b of the control PCB 272 are received in the channels 254, the end surfaces 256 of the respective channels 154 of the respective support structures 250a, 250b may abut a respective first edge of the first and second attachment tab 277a, 277b of the control PCB 272 to maintain alignment of the control PCB 272 in the transverse direction T (e.g., between the end surfaces 256 of the respective channels 254 and the rear wall 232 of the heat sink 230). In addition, when the first and second attachment tabs 277a, 277b of the control PCB 272 are received in the channels 154, the respective flaps 255 may abut a respective second edge (e.g., opposing the first edge) of the first and second attachment tab 277a, 277b of the control PCB 272 to maintain alignment of the control PCB 272 in the lateral direction A. In some examples, the control PCB 272 may be spaced apart from the barrier 248 of the enclosure 240 when the first and second attachment tabs 277a, 277b of the control PCB 272 are received in the channels 254 of the respective support structures 250a, 250b and the respective first and second attachment tabs 277a, 277b of the control PCB 272 are abutting the end surfaces 256 of the respective channels 254 (e.g., as shown in FIGS. 13 and 14). Other configurations and structures are possible to orient the control PCB 272 in the perpendicular orientations as shown in FIGS. 13-16.

The control PCB 272 may be electrically coupled to the emitter PCB 262 via one or more electrical conductors, such as wires 274 (e.g., three wires). For example, the wires 274 may be received through and soldered to respective through-holes 275 in the control PCB 272, such that the wires 274 are electrically connected to the electrical circuitry of the control PCB assembly 270. The wires 274 may extend through an opening 268 in the heat sink 230 (e.g., the rear wall 232) and may be connected to respective connectors 266 mounted to the emitter PCB 262 (e.g., as shown in FIG. 12) thereby electrically connecting the electrical circuitry of the control PCB assembly 270 to the emitters 164 of the emitter PCB assembly 160.

The control PCB assembly 270 may further comprise one or more electrical conductors, such as wires (e.g., not shown-such as the wires 176 shown in FIG. 7) for electrically connecting the lighting device 200 (e.g., the control PCB assembly 270) to be the power source for receiving power. For example, the wires may be received through and soldered to respective through-holes 276 in the control PCB 272 (e.g., as shown in FIG. 14), such that the wires are electrically connected to the electrical circuitry of the control PCB assembly 270. The wires may extend from the control PCB 272 in the first cavity portion 245a through an opening (not shown) in the barrier 248 and into the second cavity portion 245b. The enclosure 240 (e.g., the side wall 244) may further comprise knockouts 249, which may be removed to create openings through which electrical wiring from the power source is received into the second cavity portion 245b of the enclosure 240. The wires may be connected to electrical wiring from the power source within the second cavity portion 245b using, for example, twist-on wire connectors (e.g., wire nuts) or other wire connectors. In some examples, the wires may be connected to a connector (e.g., such as the connector 107 shown in FIG. 7), which may may allow the lighting device 200 (e.g., the control PCB assembly 270) to be electrically connected to the power source for receiving power.

The lighting device 200 (e.g., the control PCB assembly 270) may further comprise an antenna 290, which may allow the one or more wireless communication circuits mounted to the control PCB 272 to transmit and/or receive RF signals. The control PCB 272 may comprise an extension 278 (e.g., an extended portion) to which the antenna 290 may be coupled (e.g., mechanically and electrically coupled). The extension 278 may extend through an opening 259 in the rear wall 232 of the heat sink 230, such that the antenna 290 may extend from the extension 278 within the recess 235 of the heat sink 230. For example, the opening 259 in the rear wall 232 of the heat sink 230 may be offset from the axis 205 of the lighting device 200 (e.g., from a center of the rear wall 232 of the heat sink 230, such that the antenna 290 may be located between the reflector 220 (e.g., the outer surface 228) and the heat sink 230 (e.g., the side wall 234). The antenna 290 may extend from the extension 278 of the control PCB 270 between the reflector 220 (e.g., the outer surface 228) and the heat sink 230 (e.g., the side wall 234).

The antenna 290 may comprise an arm 292 and a base 294. The arm 292 may extend from a first end 291 (e.g., a first antenna end) at the base 294 to a second end 293 (e.g., a second antenna end) that is distal from the first end 291. For example, the antenna 290 may comprise a formed piece of conductive material, such as metal. The base 294 may be mechanically coupled (e.g., connected) to the extension 272 of the control PCB 272 and electrically coupled to the one or more wireless communication circuits mounted to the control PCB 272 (e.g., for electrically coupling the antenna 290 to the one or more wireless communication circuits mounted to the control PCB 272). For example, the base 294 may comprise a lead portion 295 and an enlarged portion 296 connected to the lead portion 295. The lead portion 295 may extend through an opening 279 in the extension 278 of the control PCB 272 (e.g., as shown in FIGS. 11 and 16) for mechanically coupling the antenna 290 to the extension 278 and electrically coupling the antenna 290 to the one or more wireless communication circuits mounted to the control PCB 272. For example, the lead portion 295 may be planar and the opening 279 may comprise a slot that may receive the lead portion 295. The enlarged portion 296 of the base 294 may not extend into the opening 279 in the extension 278 of the control PCB 272. The enlarged portion 296 of the base 294 may contact the extension 278 of the control PCB 272 when the lead portion 295 is received in the opening 279, e.g., for orienting the antenna 290 (e.g., the arm 292) relative to the control PCB 272. For example, the opening 279 may be a plated through-hole, such that the base 294 of the antenna 290 (e.g., the lead portion 295) may be soldered to the plated though-hole for mechanically connecting the antenna 290 to the control PCB 272 and electrically connecting the antenna 290 to the one or more wireless communication circuits mounted to the control PCB 272. The solder connection between the lead portion 295 and the opening 279 may form a junction between the control PCB 272 and the antenna 290. In some examples, the base 294 of the antenna 290 may be electrically connected (e.g., soldered) to an electrical pad (not shown) on the extension 278 of the control PCB 272 (e.g., without the lead portion 295 extending through the opening 279) for electrically coupling the antenna 290 to the one or more wireless communication circuits mounted to the control PCB 272.

The arm 292 of the antenna 290 may extend from the base 294 (e.g., from the extension 278 of the control PCB 272) towards the aperture 215 of the trim portion 210 when the lighting device 200 is assembled. The arm 292 of the antenna 290 may comprise, for example, a strip of metal having a width W_{ANT2} (e.g., as shown in FIG. 10) and a thickness T_{ANT1} (e.g., as shown in FIG. 13). For example, the width W_{ANT2} of the arm 292 may be approximately 0.06 inches and the thickness T_{ANT2} of the arm 192 may be approximately 0.02 inches. The arm 292 of the antenna 290 may be, for example, substantially planar (e.g., as shown in FIG. 13), and the arm 292 (e.g., a plane of the arm 292) may extend at an angle from the base 294. For example, the arm 292 (e.g., the plane of the arm)may extend from the base 294 at an angle θ_{ANT2} relative to the to the rear wall 232 of the body 231 of the heat sink 230 and the diffuser 218 of the trim portion 210 (e.g., relative to a plane extending in the longitudinal direction L and the lateral direction A) as shown in FIG. 13.

The arm 292 of the antenna 290 may curve around the reflector 220 between the reflector 220 (e.g., the outer surface 228) and the heat sink 230 (e.g., the side wall 234). The arm 292 of the antenna 290 may comprise a first portion 297, a second portion 298, and a third portion 299 (e.g., as shown in FIG. 12). The first portion 297 of the arm 292 may extend (e.g., extend linearly) in the longitudinal direction L from the base 294 towards the reflector 220 and the aperture 215 of the trim portion 210 (e.g., as shown in FIGS. 10 and 12). The second portion 298 of the arm 292 may continue to extend from the first portion 297 towards the aperture 215 of the trim portion 210. For example, the second portion 298 of the arm 292 may be curved (e.g., slightly curved) away from the reflector 220 (e.g., the outer surface 228) and towards the heat sink 230 (e.g., the side wall 234). The third portion 299 of the arm 292 may continue to extend from the second portion 298 towards the aperture 215 of the trim portion 210. For example, the third portion 299 of the arm 292 may be curved away from the heat sink 230 (e.g., the side wall 234) as the arm 292 nears the side wall 234 to avoid contacting the side wall 234 of the heat sink (e.g., since the heat sink 230 may be made of a conductive material). The antenna 290 may be characterized by a length L_{ANT2} from the junction between the control PCB 272 and the antenna 290 to the second end 293 of the antenna 290 (e.g., a total length of the enlarged portion 296 of the base 294, the first portion 297 of the arm 292, the second portion 298 of the arm 292, and the third portion 299 of the arm 292). For example, the length L_{ANT2} of the antenna 290 from the junction between the control PCB 272 and the antenna 290 to the second end 293 of the antenna 290 may be approximately 1.2 to 1.3 inches (e.g., when the communication frequency f_{COMM} of the wireless communication circuit of the control PCB assembly 270 is approximately 2.4 GHz).

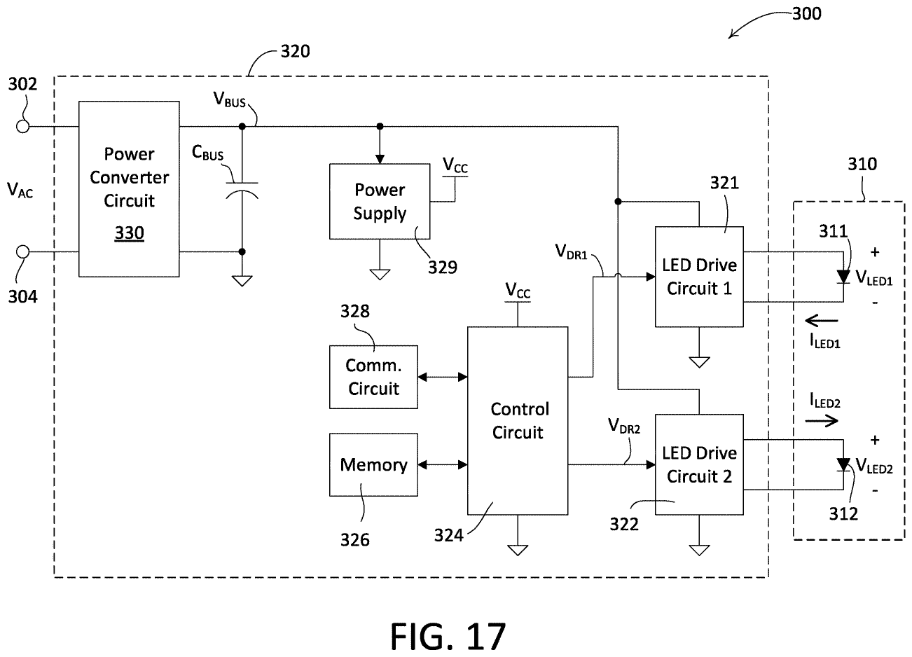

FIG. 17 is a block diagram of an example of a lighting device 300 (e.g., such as the lighting device 100 shown in FIGS. 1-6 and/or the lighting device 200 shown in FIGS. 8-14). The lighting device 300 may comprise a light source assembly 310 (e.g., such the electrical circuity of the emitter printed circuit board assemblies 160, 260) and a control assembly 320 (e.g., such as the electrical circuitry of the control printed circuit board assemblies 170, 270). The control assembly 320 may be configured to control the light source assembly 310 to control an intensity level (e.g., lighting intensity level and/or brightness) and/or color (e.g., color temperature and/or full color value) of a cumulative light emitted by the light source assembly 310. The control assembly 320 may be configured to adjust the intensity level of the cumulative light emitted by the light source assembly 310 between a low-end intensity level (e.g., a minimum intensity level) and a high-end intensity level (e.g., a maximum intensity level). For example, the light source assembly 310 may comprise one or more emitter circuits 311, 312 (e.g., LED circuits). Each of the emitter circuits 311, 312 may include one or more emitters. The emitters of each emitter circuit 311, 312 may be electrically coupled together in series and/or parallel connection. As such, the emitters of each emitter circuit 311, 312 may be controlled in unison.

Each of the emitter circuits 311, 312 is shown in FIG. 17 as a single LED, but, as noted above, may each comprise a plurality of LEDs connected in series (e.g., a string or chain of LEDs), a plurality of LEDs connected in parallel, or a suitable combination thereof, depending on the particular lighting system. The emitter circuits 311, 312 may each represent a string of one or more LEDs, where the LEDs in each string are all configured to emit light at the same color (e.g., color temperature and/or color value). The strings of LEDs represented by each of the emitter circuits 311, 312 may be configured to emit light at different colors (e.g., different color temperatures and/or color values). Further, the emitter circuits of the light source assembly 310 are not limited to LEDs, and in some examples, other technology, such as organic light-emitting diodes (OLEDs) may be used. When the light source assembly 310 is strip lighting, each strip of light may be housed separately or may be housed together in one housing or some combination thereof. While the light source assembly 310 is shown as including two emitter circuits 311, 312 in FIG. 17, in some examples, the light source assembly 310 may include less than or more than two emitter circuits. For example, the light source assembly 310 may comprise one emitter circuit, three emitter circuits, or five emitter circuits.

Each of the emitter circuits 311, 312 may be configured to emit light at a different color (e.g., color temperature and/or color value). For example, one or more of the emitter circuits 311, 312 may include broad-spectrum LEDs that may each be configured to produce light (e.g., white light) at a particular color temperature, which may be on the black body curve. For example, one of the emitter circuits 311, 312 may represent a string of emitters at a first color temperature T₁ (e.g., a cool-white color temperature, such as approximately 3000 K) and another one of the emitter circuits 311, 312 may represent a string of emitters at a second color temperature T₂ (e.g., a warm-white color temperature, such as approximately 1800 K). Although described in context of these color temperatures, the emitter circuits 311, 312 may be configured to emit light accordingly to any color temperature.

The control assembly 320 may be configured to receive power from a power source, such as an external AC power source and/or a DC power source. For example, the control assembly 320 may be configured to receive a bus voltage V_{BUS-B} from an external DC power supply via electrical connections 302, 304. The control assembly 320 may comprise an energy storage element, such as a capacitor C_{BUS}, for storing the bus voltage V_{BUS}.

The control assembly 320 may comprise LED drive circuits 321, 322 for controlling the respective emitter circuits 311, 312 of the light source assembly 310 and a control circuit 324 for controlling the LED drive circuits 321, 322. The control assembly 320 may further comprise a power converter circuit 330 configured to receive a source voltage V_{S} from an external power source, such as an alternating-current (AC) power source and/or a direct-current (DC) power source, via electrical connection 302, 304 (e.g., terminals). The power converter circuit 330 may be configured to generate a DC bus voltage V_{BUS} (e.g., approximately 15-50 volts) across an energy storage element, such as a bus capacitor C_{BUS}. For example, when the source voltage V_{S} is an AC mains line voltage received from an AC power source, the power converter circuit 330 may be configured to convert the AC mains lines voltage into the DC bus voltage V_{BUS}. The power converter circuit 330 may comprise, for example, a boost converter, a buck converter, a buck-boost converter, a flyback converter, a single-ended primary-inductance converter (SEPIC), a Ćuk converter, or any other suitable power converter circuit for generating an appropriate bus voltage.

The power converter circuit 330 may also operate as a power factor correction (PFC) circuit to adjust the power factor of the lighting device 300 towards a power factor of one. In some examples, the power converter circuit 330 may not be needed or may convert a DC source voltage of the DC power source to the DC bus voltage V_{BUS} (e.g., when the power source is a DC power source). The control assembly 320 may receive the bus voltage V_{BUS} and conduct current from the bus capacitor C_{BUS} and/or through the power converter circuit 330. The control assembly 320 may comprise a power supply 329 configured to receive the bus voltage V_{BUS} and generate a low-voltage DC supply voltage V_{CC} for powering the low-voltage circuitry of the control assembly 320.

The LED drive circuits 321, 322 may be configured to control (e.g., individually control) an individual intensity level L_{IND1}, L_{IND2} (e.g., lighting intensity level and/or luminous flux) of the light emitted by each of the respective emitter circuits 311, 312 of the light source assembly 310, respectively. The LED drive circuits 321, 322 may receive (e.g., all receive) the bus voltage V_{BUS}. Each of the LED drive circuits 321, 322 may be configured to adjust (e.g., independently adjust), for example, a magnitude (e.g., an average magnitude) of a respective LED voltage V_{LED1}, V_{LED2} produced across the respective emitter circuit 311, 312 (e.g., such that each of the emitter circuits 311, 312 may conduct a respective LED current I_{LED1}, I_{LED2}). For example, each of the LED drive circuits 321, 322 may be configured to pulse-width modulate (PWM) the respective LED voltage V_{LED1}, V_{LED2} for adjusting the individual intensity level L_{IND1}, L_{IND2} of the light emitted by the respective emitter circuit 311, 312. In some examples, each of the LED drive circuits 321, 322 may receive the bus voltage V_{BUS} and may adjust magnitudes (e.g., average magnitudes) of the respective LED currents I_{LED1}, I_{LED2} conducted through the emitter circuits 311, 312. For example, each of the LED drive circuits 321, 322 may control an instantaneous magnitude of the respective LED voltage V_{LED1}, V_{LED2} of the respective emitter circuit 311, 312 to approximately the magnitude of the bus voltage V_{BUS} (e.g., based on a PWM technique). Each of the LED circuits 311, 312 may comprise a regulation circuit, such as a switching regulator (e.g., a buck converter) for controlling the magnitudes of the respective LED voltages V_{LED1}-V_{LED3} and/or the respective LED drive currents I_{LED1}-I_{LED5}.

The control circuit 324 of the control assembly 320 may be configured to control the LED drive circuits 321, 322 to control the individual intensity level L_{IND1}-, L_{IND2} of each of the emitter circuits 311, 312 of the light source assembly 310. The control circuit 324 may comprise one or more of, for example, a microprocessor, a microcontroller, a programmable logic device (PLD), an application specific integrated circuit (ASIC), a field-programmable gate array (FPGA), or any other suitable processing device or processor. The control circuit 324 may be configured to control the LED drive circuits 321, 322 to control a present intensity level L_{PRES} (e.g., a present brightness) of a cumulative light emitted by the light source assembly 310. For example, the control circuit 324 may be configured to control the present intensity level L_{PRES} of the cumulative light emitted by the light source assembly 310 between a high-end intensity level L_{HE} (e.g., a maximum intensity level, such as approximately 100%) and a low-end intensity level L_{LE} (e.g., a minimum intensity level, such as approximately 0.1%-1.0%). In addition, the control circuit 324 may be configured to control the LED drive circuits 321, 322 to adjust a color (e.g., color temperature) of the cumulative light emitted by the light source assembly 310. For example, the control circuit 324 may be configured to control the LED drive circuits 321, 322 to adjust a present color temperature T_{PRES} of the cumulative light emitted by the light source assembly 310.

While not shown in FIG. 17, the LED drive circuits 321, 322 may generate one or more feedback signals that may be received by the control circuit 324 and may indicate magnitudes of respective operating characteristics (e.g., drive currents and/or luminous flux) of the respective emitter circuits 311, 312 of the light source assembly 310. In addition, the control assembly 320 may comprise one or more feedback circuits (not shown), which may be external to the LED drive circuits 321, 322 and may generate the one or more feedback signals that are received by the control circuit 324. The control circuit 324 may control the LED drive circuits 321, 322 to adjust the average magnitude of each of the LED voltages V_{LED1}, V_{LED2} towards respective target voltages in response to the feedback signals. In some examples, the control circuit 324 may adjust the average magnitude of each of the LED currents I_{LED1}, I_{LED2} towards respective target currents in response to the feedback signals.

The control circuit 324 may be configured to adjust (e.g., dim) the present intensity level L_{PRES} of the cumulative light emitted by the light source assembly 310 towards a target intensity level L_{TRGT} (e.g., a target brightness), which may range across a dimming range of the controllable lighting device, e.g., between the low-end intensity level L_{LE} and the high-end intensity level L_{HE}. In some examples, the individual intensity level L_{IND1}, L_{IND2} of the light emitted by each of the emitter circuits 311, 312 may be dependent upon the magnitude of the LED voltages V_{LED1}, V_{LED2} developed across and/or the LED currents I_{LED1}, I_{LED2} conducted through the emitter circuits 311, 312. In addition, the control circuit 324 may be configured to adjust the present color temperature T_{PRES} of the cumulative light emitted by the light source assembly 310 towards a target color temperature T_{TRGT}, which may range between a warm-white color temperature (e.g., approximately 1800 K) and/or a cool-white color temperature (e.g., approximately 3000 K).

The control assembly 320 may comprise a memory 326, e.g., such as a non-volatile memory. The memory 326 may be communicatively coupled to the control circuit 324 for the storage and/or retrieval of, for example, operational settings of the control assembly 320. For example, the control circuit 324 may be configured to store in the memory 326 operational characteristics (e.g., such as operational settings, control parameters, operating modes of the control assembly 320, etc.), association information for associations with other devices, and/or instructions for controlling the light source assembly 310. For example, the memory 326 may be configured to store the target intensity level L_{TRGT}, the target color temperature T_{TRGT}, the low-end intensity level LLE, and/or the high-end intensity level L_{HE}. In addition, the memory 326 may be configured to store software for execution by the control circuit 324 to operate the control assembly 320 as described herein. The memory 326 may be implemented as one or more external integrated circuits (ICs) or as one or more internal circuits of the control circuit 324. The memory 326 may comprise a computer-readable storage media or machine-readable storage media that maintains computer-executable instructions for performing one or more procedure and/or functions as described herein. For example, the memory 326 may comprise computer-executable instructions or machine-readable instructions that when executed by the control circuit configure the control circuit to provide one or more portions of the procedures described herein. The control circuit 324 may access the instructions from the memory 326 for being executed to cause the control circuit 324 to operate as described herein, or to operate one or more other devices as described herein. The memory 326 may comprise computer-executable instructions for executing configuration software. For example, the operational characteristics and/or the association information stored in the memory 326 may be configured during a configuration procedure of the control assembly 320. The control circuit 324 may be configured to store in the memory 326 configuration data, such as the light source type, which may indicate a number of emitter circuits included in the light source assembly 310, an emitter color (e.g., a color temperature and/or a color value) of the emitters in each of the emitter circuits of the light source assembly 310, and/or a brightness of the emitters.

The control assembly 320 may comprise a communication circuit 328 coupled to the control circuit 324. The communication circuit 328 may be communicatively coupled to the control circuit 324 for transmitting and receiving messages (e.g., digital messages) via signals, e.g., wired signals and/or wireless signals, such as radio-frequency (RF) signals. The communication circuit 328 may comprise one or more wired and/or wireless communication circuits. For example, the one or more wireless communication circuits of the communication circuit 328 may comprise an RF transceiver coupled to an antenna for transmitting and/or receiving RF signals. For example, the control circuit 324 may be configured to communicate messages via the RF signals using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). In addition, the one or more wireless communication circuits of the communication circuit 328 may further comprise an RF transmitter for transmitting RF signals, an RF receiver for receiving RF signals, or an infrared (IR) transmitter and/or receiver for transmitting and/or receiving IR signals. The communication circuit 328 may be implemented as one or more external integrated circuits (ICs) or as one or more internal circuits of the control circuit 324. The control circuit 324 may be configured to receive configuration data and/or control data (e.g., commands) via the message received via the communication circuit 328.

The control circuit 324 may be configured to receive and/or determine a commanded intensity level L_{CMD} and/or a commanded color temperature T_{CMD} from messages (e.g., digital messages) received via the communication circuit 328. The control circuit 324 may be configured to determine the target intensity level L_{TRGT} for the light source assembly 310 in response to the commanded intensity level L_{CMD} from the received message. In addition, control circuit 324 may be configured to determine the target color temperature T_{TRGT} for the light source assembly 310 in response to the commanded color temperature T_{CMD} from the received message. Further, the control circuit 324 may be configured to determine the target x-chromaticity coordinate X_{TRGT} and the target y-chromaticity coordinate Y_{TRGT} for the light source assembly 310 in response to the commanded x-chromaticity coordinate X_{CMD} and the commanded y-chromaticity coordinate Y_{CMD} from the received message, respectively.

The control circuit 324 may be configured to generate one or more drive signals V_{DR1}, V_{DR2} for controlling the respective LED drive circuits 321, 322. The control circuit 324 may be configured to generate each of the one or more drive signals V_{DR1}, V_{DR2} at an operating frequency for (e.g., approximately 2.05 kHz), such that each of the one or more drive signals V_{DR1}, V_{DR2} are characterized by an operating period Top (e.g., approximately 488 μsec). The control circuit 324 may be configured to pulse-width modulate one or more of the drive signals V_{DR1}, V_{DR2} according to respective duty-cycles d₁, d₂ for controlling the LED drive circuit 321, 322, such that the LED voltages V_{LED1}, V_{LED2} have duty cycles that are approximately equal to the respective duty-cycles d₁, d₂ of the drive signals V_{DR1}-V_{DR2}. For example, the control circuit 324 may be configured to adjust the duty cycle d₁ of the first drive signal V_{DRI} to adjust the individual intensity level L_{IND1} of the first emitter circuit 311 and adjust the duty cycle d₂ of the second drive signal V_{DR2} to adjust the individual intensity level L_{IND2} of the second emitter circuit 312.

The control circuit 324 may be configured to adjust the duty cycles d₁, d₂ of the respective drive signal V_{DR1}, V_{DR2} to adjust the individual intensity levels L_{IND1} L_{IND2} of the respective emitter circuits 321, 322 while maintaining the operating frequency for and/or the operating period T_{OP} at constant values. The control circuit 324 may be configured to adjust (e.g., independently adjust) the duty cycles d₁, d₂ of one or more of the respective drive signal V_{DR1}, V_{DR2} to adjust the present intensity level L_{PRES} and/or the present color temperature T_{PRES} of the cumulative light emitted by the light source assembly 310. Based on the duty cycles d₁, d₂, the control circuit 324 may be configured to drive magnitudes of the respective drive signals V_{DR1}, V_{DR2} high towards the supply voltage V_{CC} during respective on times T_{ON1}, T_{ON2} that occur with each cycle of operation of the control circuit 324 (e.g., each instance of the operating period TOP).

The control circuit 324 may be configured to hold the operating period Top constant and adjust the on times T_{ON1}, T_{ON2} to adjust the duty cycles d₁, d₂ of the respective drive signal V_{DR1}, V_{DR2}. The control circuit 324 (e.g., the LED drive circuits 321, 322) may be characterized by a minimum on time T_{ON-MIN} and a maximum on time T_{ON-MAX} to which the control circuit 324 may adjust the on times T_{ON1}, T_{ON2} of the respective drive signal V_{DR1}, V_{DR2}. For example, the minimum on time TON-MIN may represent an on time below which each of the emitter circuits 311, 312 may not emit light that is visible to the human eye (e.g., approximately 150 nanoseconds). The maximum on time T_{ON-MAX} may be equal to, for example, the operating period T_{OP}. The control circuit 324 may be configured to adjust the on times T_{ON1}, T_{ON2} by an adjustment amount Δ_{T-ON} (e.g., a minimum step size, such as, approximately 25 nanoseconds) such that the control circuit 324 may adjust the on times T_{ON1}, T_{ON2} to discrete values (e.g., achievable on times) that are spaced apart by the adjustment amount Δ_{T-ON} (e.g., between the minimum on time TON-MIN and a maximum on time T_{ON-MAX}).

In some examples, the light source assembly 310 may comprise more than two emitter circuits, such as three or five emitter circuits. When the light source assembly 310 comprises more than two emitter circuits, one or more of the emitter circuits may include broad-spectrum LEDs that may each be configured to produce light (e.g., white light) at a particular color temperature, which may be on the black body curve. For example, one of the emitter circuits may represent a string of emitters at a first color temperature T₁ (e.g., a cool-white color temperature, such as approximately 3000 K) and another one of the emitter circuits may represent a string of emitters at a second color temperature T₂ (e.g., a warm-white color temperature, such as approximately 1800 K). In addition, one or more of the emitter circuits may include non-broad-spectrum LEDs that may each be configured to produce light at a peak emission wavelength, which may specify the color (e.g., the color value) of the light emitted by the respective emitter circuit. For example, one of the emitter circuits may represent a string of red emitters, one of the emitter circuits may represent a string of green emitters, and/or one of the emitter circuits may represent a string of blue emitters. Although described in context of these colors (e.g., color temperatures and/or color values), the emitter circuits may be configured to emit light accordingly to any color (e.g., at any wavelength and/or color temperature).

When the light source assembly 310 comprises more than two emitter circuits, the control assembly 320 may comprise more than the two LED drive circuits 321, 322. The control circuit 324 may be configured to control the LED drive circuits to control a present intensity level L_{PRES} (e.g., a present brightness) of a cumulative light emitted by the light source assembly 310. In addition, the control circuit 324 may be configured to control the LED drive circuits to adjust a color (e.g., color temperature and/or color value) of the cumulative light emitted by the light source assembly 310. For example, the control circuit 324 may be configured to control the LED drive circuits to adjust a present color temperature T_{PRES} of the cumulative light emitted by the light source assembly 310. Further, the control circuit 324 may be configured to control the LED drive circuits to adjust a present color value (e.g., which may be defined by a present x-chromaticity coordinate X_{PRES} and a present y-chromaticity coordinate Y_{PRES}) of the cumulative light emitted by the light source assembly 310. In addition, the present color value could be defined by other color values (e.g., as defined in other color spaces). For example, the present color value by be a red-green-blue (RGB) color value (e.g., as defined by a red value, a green value, and a blue value, and/or a hex value in the RGB color space) a UVW color value (e.g., as defined by a u-chromaticity value, a v-chromaticity value, and a lightness index (e.g., w) value in the UVW color space), a wavelength, and/or other suitable color value. The control circuit 324 may be configured to receive and/or determine a commanded intensity level L_{CMD}, a commanded color temperature T_{CMD}, and/or a commanded color value (e.g., as defined by a commanded x-chromaticity coordinate X_{CMD} and a commanded y-chromaticity coordinate Y_{CMD}) from messages (e.g., digital messages) received via the communication circuit 328.

When the light source assembly comprises three emitter circuits, the control assembly 320 may comprise an additional LED drive circuit, such as a third drive circuit (e.g., in addition to the first and second LED drive circuits 321, 322). In a first example, each of the three emitter circuits may include one or more broad-spectrum LEDs configured to emit light (e.g., white light) at a color temperature (e.g., a different color temperature) that is along the black body curve. For example, the first emitter circuit may represent a string of broad-spectrum LEDs at a first color temperature T₁, the second emitter circuit may represent a string of broad-spectrum LEDs at a second color temperature T₂, and the third emitter circuit may represent a string of broad-spectrum LEDs at a third color temperature T₃. In a second example, the first and second emitter circuits may include one or more broad-spectrum LEDs configured to emit light (e.g., white light) at a color temperature (e.g., a different color temperature) that is along the black body curve, while the third emitter circuit may include one or more non-broad-spectrum LEDs configured to emit light, for example, at a color value (e.g., such as a green color value) that is not along the black body curve.

In a third example, each of the three emitter circuits may include one or more non-broad-spectrum LEDs configured to emit light at a color value (e.g., not limited to white colors on the black body curve). For example, the first emitter circuit may represent a string of non-broad-spectrum LEDs at a first color value (e.g., a red color value), the second emitter circuit may represent a string of non-broad-spectrum LEDs at a second color value (e.g., a blue color value), and the third emitter circuit may represent a string of non-broad-spectrum LEDs at a third color value (e.g., a green color value). When the light source assembly 310 comprises the three emitter circuits, the control circuit 324 may be configured to generate three drive signals for controlling the three LED drive circuits to control the present color temperature T_{PRES} and/or the present color value (e.g., as defined by the present x-chromaticity coordinate X_{PRES} and the present y-chromaticity coordinate Y_{PRES}) of the cumulative light emitted by the light source assembly 310.

When the light source assembly comprises five emitter circuits, the control assembly 320 may comprise three additional LED drive circuits, such as a third LED drive circuit, a fourth LED drive circuit, and a fifth LED drive circuit (e.g., in addition to the first and second LED drive circuits 321, 322). For example, the two of the five emitter circuits of the light source assembly 310 may include broad-spectrum LEDs configured to emit light (e.g., white light) at a color temperature (e.g., a different color temperature) that is along the black body curve, and three of the five emitter circuits of the light source assembly 310 may include one or more non-broad-spectrum LEDs configured to emit light at a color value (e.g., not limited to white colors on the black body curve). For example, the first emitter circuit may be a string of broad-spectrum LEDs at a first color temperature T₁ and the second emitter circuit may be a string of broad-spectrum LEDs at a second color temperature T₂. In addition, the third emitter circuit may be a string of non-broad-spectrum LEDs at a first color value (e.g., a red color value), the fourth emitter circuit may be a string of non-broad-spectrum LEDs at a second color value (e.g., a blue color value), and the fifth emitter circuit may be a string of non-broad-spectrum LEDs at a third color value (e.g., a green color value). The control circuit 324 may be configured to generate five drive signals for controlling the five LED drive circuits to control the present color temperature T_{PRES} and/or the present color value (e.g., as defined by the present x-chromaticity coordinate X_{PRES} and the present y-chromaticity coordinate YPRES) of the cumulative light emitted by the light source assembly 310.

In some examples, the light source assembly 310 controlled by the control assembly 320 may comprise a single emitter circuit, such as the emitter circuit 311 (e.g., the light source assembly 310 may not comprise the emitter circuit 312). When the light source assembly 310 comprises just the one emitter circuit 311, the control circuit 324 may be configured to generate (e.g., only generate), for example, the first drive signal V_{DR1} for controlling the first LED drive circuit 321 to control (e.g., only control) the present intensity level L_{PRES} of the cumulative light emitted by the light source assembly 310.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

1. A lighting device configured to be mounted in an opening in a building structure, the lighting device comprising:
an emitter printed circuit board assembly comprising a plurality of emitters mounted to an emitter printed circuit board;
a trim portion defining an aperture through which the emitters of the emitter printed circuit board may be configured to emit light;
a heat sink comprising a body that includes a rear wall and at least one side wall extending from the rear wall, such that the rear wall and the at least one side wall of the heat sink define a recess in which the emitter printed circuit board assembly is received;
a reflector comprising a body having a first opening at a first end and a second opening at a second end, the body of the reflector extending into the recess of the heat sink such that the emitters of the emitter printed circuit board assembly are configured to emit light through the first opening of the reflector, the reflector configured to reflect the light emitted by the emitters through the second opening of the reflector;
a control printed circuit board assembly comprising a control printed circuit board having mounted thereto one or more drive circuits for controlling the emitters of the emitter printed circuit board assembly and one or more wireless communication circuits configured to communicate radio-frequency (RF) signals, the control printed circuit board comprising an extension extending through an opening in the rear wall of the heat sink and into the recess defined by the heat sink; and
an antenna electrically coupled to the one or more wireless communication circuits mounted to the second printed circuit board, the antenna comprising a base and an arm extending from the base, the base mechanically connecting the antenna to the extension of the control printed circuit board, the arm of the antenna extending from a first end at the base, towards the reflector and the aperture of the trim portion, and to a second end distal the first end.

2. The lighting device of claim 1, wherein the arm of the antenna is planar and extends from the base at an angle with respect to the rear wall of the heat sink.

3. The lighting device of claim 2, wherein the arm of the antenna comprises a first portion that extends linearly from the base towards the aperture of the trim portion.

4. The lighting device of claim 3, wherein the arm of the antenna comprises a second portion that extends from the first portion and is curved away from the reflector and towards the at least one side wall of the heat sink.

5. The lighting device of claim 4, wherein the arm of the antenna comprises a third portion that extends from the second portion and is curved away from the heat sink.

6. The lighting device of claim 4, wherein the body of the reflector is conically-shaped.

7. The lighting device of claim 2, wherein the antenna curves around the reflector between an outer surface of the reflector and the at least one side wall of the heat sink.

8. The lighting device of claim 7, wherein the trim portion is coupled to the heat sink, and the antenna is configured to extend towards the at least one side wall of the heat sink as the arm extends from the base towards the aperture of the trim portion.

9. The lighting device of claim 8, wherein the antenna is configured to extend away from the at least one side wall of the heat sink as the arm nears the at least one side wall of the heat sink.

10. The lighting device of claim 2, wherein the base of the antenna comprises a lead portion configured to extend through an opening in the extension of the control printed circuit board for mechanically coupling the antenna to the extension and electrically coupling the antenna to the one or more wireless communication circuits mounted to the control printed circuit board.

11. The lighting device of claim 10, wherein the base of the antenna comprises an enlarged portion that is connected to the lead portion and does not extend into the opening in the extension of the control printed circuit board.

12. The lighting device of claim 2, wherein the reflector is made from a non-conductive material.

13. The lighting device of claim 12, wherein the reflector is made from white plastic.

14. The lighting device of claim 1, further comprising:
an enclosure configured to be attached to the heat sink and defining a cavity in which the control printed circuit board is received, the enclosure configured to support the control printed circuit board such that the control printed circuit board is oriented perpendicular to the rear wall of the heat sink.

15. The lighting device of claim 14, wherein the enclosure comprises a rear wall and a side wall extending from the rear wall to form the cavity, the enclosure further comprising support structures on opposing sides of the side wall for supporting the control printed circuit board.

16. The lighting device of claim 15, wherein the control printed circuit board comprises attachment tabs on opposing edges of the control printed circuit board, and each of the support structures defines a respective channel configured to receive the respective attachment tabs of the control printed circuit board.

17. The lighting device of claim 16, wherein each of the support structures comprises a respective protruding portion extending into the cavity of the enclosure, wherein the respective channels are formed in the respective protruding portions.

18. The lighting device of claim 17, wherein the enclosure is made from a conductive material, and each of the support structures comprises a flap that extends from the side wall, folds over outside of the cavity, and abuts the side wall to cover the channel in the respective protruding portion.

19. The lighting device of claim 16, wherein the enclosure is made from a non-conductive material, and each of the support structures is formed in the side wall of the enclosure.

20. The lighting device of claim 1, wherein the emitter printed circuit board is mounted to the rear wall of the heat sink, such that the emitters of the emitter printed circuit board assembly are thermally coupled to the heat sink via the emitter printed circuit board.

21.-80. (canceled)
